(19) United States
(12) Patent Application Publication
(10) Pub. No.: US 2020/0194848 A1
(43) Pub. Date: Jun. 18, 2020

(54) BATTERY SYSTEM

(71) Applicant: Panasonic Intellectual Property Management Co., Ltd., Osaka (JP)

(72) Inventor: Kazuyoshi HONDA, Osaka (JP)

(21) Appl. No.: 16/801,757

(22) Filed: Feb. 26, 2020

Related U.S. Application Data
(63) Continuation-in-part of application No. 15/846,177, filed on Dec. 18, 2017.

(30) Foreign Application Priority Data
Jan. 25, 2017 (JP) 2017-011368

(51) Int. Cl. H01M 10/48; H01M 2/12

(52) U.S. Cl. CPC H01M 10/48; H01M 2/12

(57) ABSTRACT

A battery system includes a container including a first outlet; a power generation element contained in the container and disposed inside the container; a measurement unit that measures a gas concentration inside the container; a first opening and closing unit connected to the first outlet; and a control unit that controls the first opening and closing unit. The measurement unit measures the gas concentration while the first opening and closing unit is in a closed state, and the control unit sets the first opening and closing unit to an open state after the gas concentration has exceeded a first threshold.

### CROSS-REFERENCE OF RELATED APPLICATIONS

This application is a Continuation-in-Part of U.S. patent application Ser. No. 15/846,177, filed on Dec. 18, 2017, which in turn claims the benefit of Japanese Application No. 2017-011368, filed on Jan. 25, 2017, the entire disclosures of which Applications are incorporated by reference herein.

### BACKGROUND

### 1. Technical Field

The present disclosure relates to a battery system.

### 2. Description of the Related Art

Japanese Unexamined Patent Application Publication No. 2015-41598 discloses an apparatus that detects breakage of a battery including a sulfide-based solid electrolyte.

### SUMMARY

In the related art, it is desirable to increase the gas detection sensitivity.

In one general aspect, the techniques disclosed here feature a battery system including a container including a first outlet; a power generation element contained in the container and disposed inside the container; a measurement unit that measures a gas concentration inside the container; a first opening and closing unit connected to the first outlet; and a control unit that controls the first opening and closing unit. The measurement unit measures the gas concentration while the first opening and closing unit is in a closed state, and the control unit sets the first opening and closing unit to an open state after the gas concentration has exceeded a first threshold.

According to an aspect of the present disclosure, the gas detection sensitivity can be increased.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a general configuration of a battery system according to a first embodiment;

FIG. 2 is a flowchart illustrating an exemplary control method according to the first embodiment;

FIG. 3 illustrates a general configuration of a battery system according to the first embodiment;

FIG. 4 is a cross-sectional view of a general configuration of an example of a power generation element according to the first embodiment;

FIG. 5 is a cross-sectional view of a general configuration of another example of the power generation element according to the first embodiment;

FIGS. 6A to 6C are cross-sectional views of stacking units in the power generation element according to the first embodiment;

FIG. 7 illustrates a general configuration of a battery system according to a second embodiment;

FIG. 8 is a flowchart illustrating an exemplary control method according to the second embodiment;

FIG. 9 is a flowchart illustrating an exemplary control method according to the second embodiment;

FIG. 10 is a flowchart illustrating an exemplary control method according to the second embodiment;

FIG. 11 illustrates a general configuration of a battery system according to the second embodiment;

FIG. 12 illustrates a general configuration of a battery system according to a third embodiment;

FIG. 13 illustrates a general configuration of a battery system according to the third embodiment;

FIG. 14 is a flowchart illustrating an exemplary control method according to the third embodiment;

FIG. 15 illustrates a general configuration of a battery system according to the third embodiment;

FIG. 16 illustrates a general configuration of a battery system according to the third embodiment;

FIG. 17 illustrates a general configuration of a battery system according to the third embodiment;

FIG. 18 illustrates a general configuration of a battery system according to the third embodiment;

FIG. 19 is a flowchart illustrating an exemplary control method according to the third embodiment;

FIG. 20 illustrates a general configuration of a battery system according to the third embodiment;

FIG. 21 is a flowchart illustrating an exemplary control method according to the third embodiment;

FIG. 22 illustrates a general configuration of a battery system according to the third embodiment;

FIG. 23 illustrates a general configuration of a battery system according to a fourth embodiment;

FIG. 24 is a flowchart illustrating an exemplary control method according to the fourth embodiment;

FIG. 25 is a flowchart illustrating an exemplary control method according to the fourth embodiment;

FIG. 26 is a flowchart illustrating an exemplary control method according to the fourth embodiment;

FIG. 27 illustrates a general configuration of a battery system according to the fourth embodiment;

FIG. 28 illustrates a general configuration of a battery system according to the fourth embodiment;

FIG. 29 is a flowchart illustrating an exemplary control method according to the fourth embodiment;

FIG. 30 illustrates a general configuration of a battery system according to the fourth embodiment;

FIG. 31 illustrates a general configuration of a battery system according to the fourth embodiment;

FIG. 32 is a flowchart illustrating an exemplary control method according to the fourth embodiment;

FIG. 33 is a flowchart illustrating an exemplary control method according to the fourth embodiment;

FIGS. 34A and B are a flowchart illustrating an exemplary control method according to the fourth embodiment;

FIG. 35 illustrates an operation example of a battery system according to the fifth embodiment;

FIG. 36 illustrates an operation example of a battery system according to the fifth embodiment; and

FIG. 37 illustrates an operation example of a battery system according to the fifth embodiment.

### DETAILED DESCRIPTION

Embodiments will be described below with reference to the drawings.

### First Embodiment

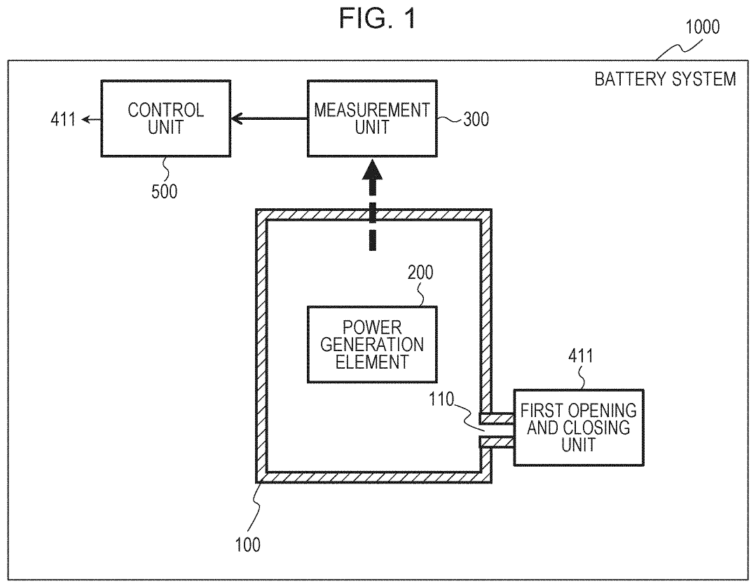

FIG. 1 illustrates a general configuration of a battery system 1000 according to a first embodiment.

The battery system 1000 according to the first embodiment includes a container 100, a power generation element 200, a measurement unit 300, a first opening and closing unit 411, and a control unit 500.

The container 100 includes a first outlet 110.

The power generation element 200 is contained in the container 100. That is, the power generation element 200 is disposed inside the container 100.

The measurement unit 300 measures the gas concentration inside the container 100.

The first opening and closing unit 411 is connected to the first outlet 110.

The control unit 500 controls the first opening and closing unit 411.

The measurement unit 300 measures the gas concentration (i.e., a first gas concentration) while the first opening and closing unit 411 is in a closed state.

After the gas concentration (i.e., the gas concentration inside the container 100 measured by the measurement unit 300 while the first opening and closing unit 411 is in a closed state) has exceeded a first threshold (predetermined threshold), the control unit 500 sets the first opening and closing unit 411 to an open state.

With the above configuration, the gas detection sensitivity inside the container 100 can be increased. That is, the gas is detected while the first opening and closing unit 411 is in a closed state (i.e., while the power generation element 200 is hermetically sealed within the container 100), and thus, the gas can be detected in a state in which the gas is retained inside the container 100. Accordingly, a high concentration of the gas can be detected inside the container 100 (i.e., without diffusing the gas to the outside of the container 100). As a result, the gas detection value (measured gas concentration) can be obtained at a higher accuracy. Accordingly, for example, on the basis of the gas detection value obtained at a high accuracy, the timing for discharging the gas can be determined more appropriately. In addition, for example, on the basis of the gas detection value obtained at a high accuracy, the progress of degradation in the battery can be obtained more accurately, and the future degradation can be estimated more accurately.

Furthermore, with the above configuration, when the concentration of the gas retained inside the container 100 exceeds the predetermined first threshold, the first opening and closing unit 411 to an open state, and thereby all the retained gas can be discharged through the first outlet 110. Thus, for example, the gas generated inside the container 100 can be discharged in a shorter period of time and more reliably. Accordingly, the gas concentration inside the container 100 can be maintained more efficiently at a safe level in accordance with a certain standard (e.g., a standard determined on the basis of the above-described first threshold).

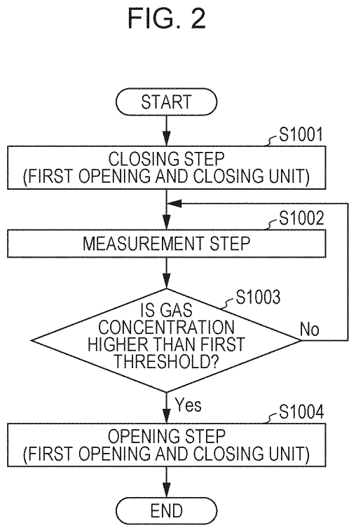

FIG. 2 is a flowchart illustrating an exemplary control method according to the first embodiment.

The control method illustrated in FIG. 2 includes a closing step S1001, a measurement step S1002, a determination step S1003, and an opening step S1004.

In the closing step S1001, the control unit 500 sets the first opening and closing unit 411 to a closed state.

The measurement step S1002 is performed after the closing step S1001. In the measurement step S1002, the measurement unit 300 measures the gas concentration while the first opening and closing unit 411 is in a closed state.

The determination step S1003 is performed after the measurement step S1002. In the determination step S1003, the control unit 500 determines whether the gas concentration (i.e., the gas concentration inside the container 100 measured by the measurement unit 300 while the first opening and closing unit 411 is in a closed state) is higher than the first threshold. If it is determined that the gas concentration is not higher than the first threshold, the measurement step S1002 is performed again. If it is determined that the gas concentration is higher than the first threshold, the opening step S1004 is performed.

The opening step S1004 is performed after determination step S1003. In the opening step S1004, the control unit 500 sets the first opening and closing unit 411 to an open state.

As the shape of the container 100, the shape (e.g., cube or cylinder) of an outer cover body of a typically known battery cell (or a battery module, a battery pack, or the like) may be used. The container 100 may be, for example, a box, a housing, or the like.

The container 100 may be formed of the material (e.g., metal or resin) for an outer cover body of a typically known battery cell (or a battery module, a battery pack, or the like).

Alternatively, if the power generation element 200 is, for example, a large battery including a plurality of battery packs, the container 100 may be a larger structure (building) that can surround (e.g., surround and hermetically seal) the large battery.

The first outlet 110 may be an opening provided on a side surface of the container 100 as illustrated in FIG. 1. Alternatively, the first outlet 110 may be provided at a portion (e.g., corner) other than the side surface of the container 100. The shape of the first outlet 110 may be circular, elliptic, rectangular, linear, or the like.

The control unit 500 may include, for example, a processor and a memory. The processor may be, for example, a central processing unit (CPU), a micro-processing unit (MPU), or the like. In this case, the processor may read and execute a program stored in the memory to perform a control method described in an embodiment of the present disclosure.

Note that the first threshold to be compared with the measurement result (measured gas concentration) obtained by the measurement unit 300 may be stored in the control unit 500 (e.g., memory) in advance. The first threshold may be determined in accordance with the type of the gas that is a detection target.

Note that in the present disclosure, the expression “the control unit 500 controls a predetermined unit (e.g., the first opening and closing unit 411)” encompasses “the control unit 500 operates (executes) at least one of starting and stopping the operation of the predetermined unit (e.g., the first opening and closing unit 411)”.

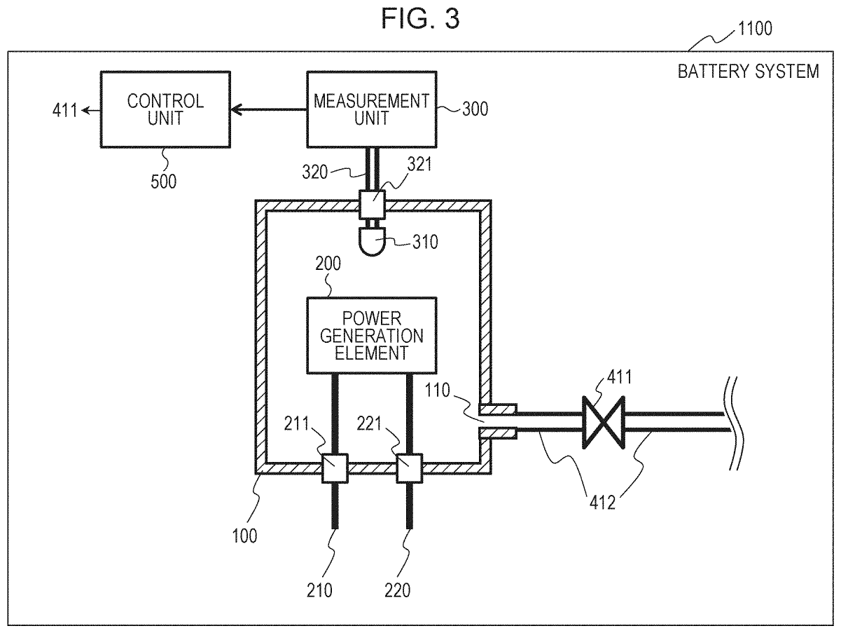

FIG. 3 illustrates a general configuration of a battery system 1100 according to the first embodiment.

The battery system 1100 according to the first embodiment further includes the following configuration in addition to the above-described configuration of the battery system 1000 according to the first embodiment.

According to the first embodiment, as illustrated in FIG. 3, the measurement unit 300 may include a sensor element 310 and a connection line 320.

The sensor element 310 is a member that detects the presence of a gas inside the container 100.

As illustrated in FIG. 3, the sensor element 310 is disposed inside the container 100.

In this case, the measurement unit 300 may measure (or calculate) the gas concentration inside the container 100 on the basis of a signal from the sensor element 310.

As the sensor element 310, any of typically known gas detection sensors (e.g., constant potential electrolysis type, semiconductor type, or thermal conduction type) is used alone or in combination.

A sensing region may be provided in the sensor element 310. The sensing region of the sensor element 310 may include, for example, a resistance variable material (e.g., metal such as copper, nickel, or iron) whose electrical resistance is changed by a chemical reaction with the gas (e.g., hydrogen sulfide) that is the detection target.

The connection line 320 is a pair of connection lines connected to the sensing region of the sensor element 310.

The connection line 320 that is led outside the container 100 is connected to the measurement unit 300.

For example, a current may be applied between the pair of connection lines, which is the connection line 320, and the measurement unit 300 may detect the voltage between the pair of connection lines. In this case, the measurement unit 300 may include, for example, a current applying unit (e.g., current source) and a voltage measuring unit (e.g., voltmeter). In this case, the measurement signal (signal to be input to the control unit 500) generated by the measurement unit 300 may be a signal correlated with the measurement result of the voltage measuring unit. As configurations of the current applying unit and the voltage measuring unit, typically known configurations may be used.

Alternatively, for example, a voltage may be applied between the pair of connection lines, which is the connection line 320, and the measurement unit 300 may detect the current between the pair of connection lines. In this case, the measurement unit 300 may include, for example, a voltage applying unit (e.g., voltage source) and a current measuring unit (e.g., ammeter). In this case, the measurement signal (signal to be input to the control unit 500) generated by the measurement unit 300 may be a signal correlated with the measurement result of the current measuring unit. As configurations of the voltage applying unit and the current measuring unit, typically known configurations may be used.

Note that the connection line 320 may be led outside the container 100 through a sealing portion 321 provided in the container 100. The sealing portion 321 may be formed of a typically known sealing material (e.g., thermoplastic resin, thermosetting resin, or photo-curable resin).

As described above, the measurement unit 300 may include the sensor element 310.

Note that the measurement unit 300 may detect a predetermined parameter (e.g., pressure, gas component, or temperature) in the space inside the container 100 by using the sensor element 310. In this case, on the basis of a predetermined parameter value that has been detected, the measurement unit 300 may calculate the gas concentration inside the container 100.

Alternatively, the measurement unit 300 may include a communicating tube that communicates with the inside of the container 100. In this case, the measurement unit 300 may detect a gas that is introduced from the inside of the container 100 through the communicating tube. That is, the gas concentration inside the container 100 may be measured on the basis of the gas introduced through the communicating tube. In this case, as the measurement unit 300, a typically known gas analyzing apparatus may be used.

Note that in the present disclosure, the expression “the measurement unit 300 measures the gas concentration” encompasses “the measurement unit 300 outputs the signal (measured value) indicating the measurement result of the gas concentration”.

Note that in the present disclosure, the gas that is the measurement target of the measurement unit 300 may be, for example, a gas that may be generated in the power generation element 200 as a result of long-term use of the power generation element 200. Alternatively, the gas that is the measurement target of the measurement unit 300 may be, for example, a gas (e.g., hydrogen sulfide gas) that may be generated as a result of a reaction between a material included in the power generation element 200 and the outside air (e.g., moisture) that has entered the container 100.

The first opening and closing unit 411 is an apparatus that has any of two states, a closed state and an open state, in accordance with a control signal from the control unit 500, for example.

In this case, the expression “the first opening and closing unit 411 is in a closed state” encompasses “the inside of the container 100 is not connected to the outside thereof through the first outlet 110”.

On the other hand, the expression “the first opening and closing unit 411 is in an open state” encompasses “the inside of the container 100 is connected to the outside thereof through the first outlet 110”.

Note that according to the first embodiment, as illustrated in FIG. 3, the first opening and closing unit 411 may be a valve (e.g., control valve). In this case, the valve is controlled to be open and closed in accordance with a control signal from the control unit 500, and thereby the state of connection/disconnection between the first outlet 110 and the outside of the container 100 may be switched.

That is, while the valve is in a closed state, the gas that is present inside the container 100 cannot move to the outside of the container 100 through the first outlet 110 (and the first opening and closing unit 411).

On the other hand, while the valve is in an open state, the gas that is present inside the container 100 can move to the outside of the container 100 through the first outlet 110 (and the first opening and closing unit 411).

Note that in the present disclosure, the expression “an opening and closing unit (e.g., first opening and closing unit 411, second opening and closing unit 421, or inlet opening and closing unit 621) is connected to an opening (e.g., first outlet 110, second outlet 120, or inlet 130) of the container 100” encompasses “the opening and closing unit is connected to the opening of the container 100 through another member (e.g., connection path (pipe) or gas discharge unit)”.

Note that the battery system 1100 according to the first embodiment includes a first discharge path 412.

The first discharge path 412 may be, for example, a hollow pipe-like member (e.g., pipe) or the like. The first discharge path 412 may have a typically known pipe structure.

The first discharge path 412 is connected to the first opening and closing unit 411. For example, as illustrated in FIG. 3, the first opening and closing unit 411 may be provided in a path connecting an end of the first discharge path 412 to the first outlet 110.

Note that the battery system 1100 according to the first embodiment includes a first electrode terminal 210 and a second electrode terminal 220.

As illustrated in FIG. 3, the first electrode terminal 210 may have an end contained in the inside of the container 100 and an end exposed to the outside of the container 100. In this case, the end contained in the inside of the container 100 may be electrically connected to the power generation element 200.

Note that the first electrode terminal 210 may be led to the outside of the container 100 through a sealing portion 211 provided in the container 100. That is, a sealant (e.g., resin) may be applied to the portion where the container 100 contacts the first electrode terminal 210 for sealing and hermetically sealing.

As illustrated in FIG. 3, the second electrode terminal 220 may have an end contained in the inside of the container 100 and an end exposed to the outside of the container 100. In this case, the end contained in the inside of the container 100 may be electrically connected to the power generation element 200.

Note that the second electrode terminal 220 may be led to the outside of the container 100 through a sealing portion 221 provided in the container 100. That is, a sealant (e.g., resin) may be applied to the portion where the container 100 contacts the second electrode terminal 220 for sealing and hermetically sealing.

Note that an end of the first electrode terminal 210 may be electrically connected to a positive electrode (e.g., positive-electrode current collector) of the power generation element 200. In this case, an end of the second electrode terminal 220 may be electrically connected to a negative electrode (e.g., negative-electrode current collector) of the power generation element 200. In this case, the first electrode terminal 210 serves as a positive electrode terminal, and the second electrode terminal 220 serves as a negative electrode terminal.

Alternatively, an end of the first electrode terminal 210 may be electrically connected to a negative electrode (e.g., negative-electrode current collector) of the power generation element 200. In this case, an end of the second electrode terminal 220 may be electrically connected to a positive electrode (e.g., positive-electrode current collector) of the power generation element 200. In this case, the first electrode terminal 210 serves as a negative electrode terminal, and the second electrode terminal 220 serves as a positive electrode terminal.

When the first electrode terminal 210 and the second electrode terminal 220 are connected to a charging apparatus, the power generation element 200 is charged. In addition, when the first electrode terminal 210 and the second electrode terminal 220 are connected to a load, the power generation element 200 is discharged.

Note that in the first embodiment, the first outlet 110, the sensor element 310, and electrode terminals (the first electrode terminal 210 and the second electrode terminal 220) may be provided on different faces of the container 100 as illustrated in FIG. 3, or may be provided on the same face.

The power generation element 200 is, for example, a power generation unit (e.g., battery) having charging and discharging characteristics.

Note that in the first embodiment, the power generation element 200 may be a battery cell.

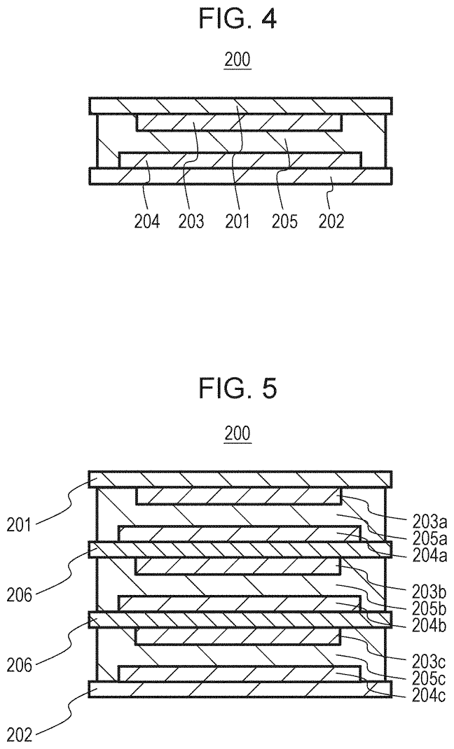

FIG. 4 is a cross-sectional view of a general configuration of an example of the power generation element 200 according to the first embodiment.

As illustrated in FIG. 4, the power generation element 200 according to the first embodiment may include a first current collector 201, a second current collector 202, a first active material layer 203, a second active material layer 204, and a solid electrolyte layer 205.

The first active material layer 203 is a layer including a first active material. The second active material layer 204 is a layer including a second active material.

The solid electrolyte layer 205 is a layer including a solid electrolyte. The solid electrolyte layer 205 is disposed between the first active material layer 203 and the second active material layer 204. In this manner, the power generation element 200 according to the first embodiment may be an all-solid-state battery.

The all-solid-state battery uses a solid electrolyte instead of a liquid electrolyte. Since a liquid electrolyte is not used, the all-solid-state battery has a low burning risk and high safety. Some solid electrolytes having high ion conductivity have low chemical stability. The battery system according to an embodiment of the present disclosure takes measures against the drawbacks due to low chemical stability, while using characteristics of materials. That is, for example, in a case of using a sulfide-based solid electrolyte, a hydrogen sulfide gas may be generated as a result of a reaction with moisture in the air. Accordingly, if a sulfide solid electrolyte is used for an all-solid-state battery system as the battery system according to an embodiment of the present disclosure, the power generation element 200 is used by being enclosed in the hermetic container 100. In this case, according to the battery system according to an embodiment of the present disclosure, the above-described control method using the measurement unit 300 can be performed as a measure against the generation of a hydrogen sulfide gas.

Note that the first active material layer 203 may be a positive-electrode active material layer. In this case, the first active material is a positive-electrode active material, the first current collector 201 is a positive-electrode current collector, the second active material layer 204 is a negative-electrode active material layer, the second active material is a negative-electrode active material, and the second current collector 202 is a negative-electrode current collector.

Alternatively, the first active material layer 203 may be a negative-electrode active material layer. In this case, the first active material is a negative-electrode active material, the first current collector 201 is a negative-electrode current collector, the second active material layer 204 is a positive-electrode active material layer, the second active material is a positive-electrode active material, and the second current collector 202 is a positive-electrode current collector.

As illustrated in FIG. 4, the first active material layer 203, the second active material layer 204, and the solid electrolyte layer 205 are formed between the first current collector 201 and the second current collector 202. The first active material layer 203 is formed on the first current collector 201. The second active material layer 204 is formed on the second current collector 202. The solid electrolyte layer 205 is formed on the first active material layer 203 or the second active material layer 204.

The order for forming these layers in the manufacturing process is not limited to a particular order. For example, sequential stacking, bonding, and transferring may be employed in combination.

The first active material layer 203 and the second active material layer 204 may be formed in a smaller area than the area in which the first current collector 201 and the second current collector 202 are formed. The solid electrolyte layer 205 may be formed in a larger area than the area in which the first active material layer 203 and the second active material layer 204 are formed. Thus, it is possible to prevent a short circuit resulting from the positive-electrode layer and the negative-electrode layer being in direct contact with each other.

The area in which the first active material layer 203 is formed may have substantially the same size as that of the area in which the second active material layer 204 is formed. Alternatively, the area in which the positive-electrode active material layer is formed may be larger than the area in which the negative-electrode active material layer is formed. Thus, for example, it is possible to prevent a decrease in the reliability of the battery as a result of lithium precipitation.

The area in which the solid electrolyte layer 205 is formed may have substantially the same size as that of the area in which the first current collector 201 or the second current collector 202 is formed. Alternatively, the area in which the solid electrolyte layer 205 is formed may be smaller than the area in which the first current collector 201 or the second current collector 202 is formed.

As a constituent of the positive-electrode current collector, for example, a metal such as a stainless use steel (SUS) or Al may be used. The thickness of the positive-electrode current collector may be, for example, 5 to 100 μm.

As the positive-electrode active material included in the positive-electrode active material layer, a known positive-electrode active material (e.g., lithium cobaltite or LiNO) may be used. As a material for the positive-electrode active material, any material in which Li can be desorbed and inserted may be used.

As a constituent of the positive-electrode active material layer, a known solid electrolyte (e.g., inorganic solid electrolyte) may be used. As an inorganic solid electrolyte, a sulfide solid electrolyte, an oxide solid electrolyte, or the like may be used. As a sulfide solid electrolyte, for example, a mixture of Li₂S:P₂S₅ may be used. The surface of the positive-electrode active material may be coated with a solid electrolyte. In addition, as a constituent of the positive-electrode active material layer, a conductive material (e.g., acetylene black), a binder (e.g., polyvinylidene fluoride), or the like may be used.

These constituents for the positive-electrode active material layer may be kneaded with a solvent to obtain a coating material in the form of a paste, and the coating material may be applied onto the surface of the positive-electrode current collector and dried, thereby forming the positive-electrode active material layer. In order to increase the density of the positive-electrode active material layer, the layer may be pressed after being dried. The thickness of the positive-electrode active material layer formed in this manner is, for example, 5 to 300 μm.

As a constituent of the negative-electrode current collector, for example, a metal such as SUS or Cu may be used. The thickness of the negative-electrode current collector may be, for example, 5 to 100 μm.

As the negative-electrode active material included in the negative-electrode active material layer, a known negative-electrode active material (e.g., graphite) may be used. As a material for the negative-electrode active material, any material in which Li can be desorbed and inserted may be used.

As a constituent of the negative-electrode active material layer, a known solid electrolyte (e.g., inorganic solid electrolyte) may be used. As an inorganic solid electrolyte, a sulfide solid electrolyte, an oxide solid electrolyte, or the like may be used. As a sulfide solid electrolyte, for example, a mixture of Li₂S:P₂S₅ may be used. In addition, as a constituent of the negative-electrode active material layer, a conductive material (e.g., acetylene black), a binder (e.g., polyvinylidene fluoride), or the like may be used.

These constituents for the negative-electrode active material layer may be kneaded with a solvent to obtain a coating material in the form of a paste, and the coating material may be applied onto the surface of the negative-electrode current collector and dried, thereby forming the negative-electrode active material layer. In order to increase the density of the negative-electrode active material layer, the negative-electrode plate may be pressed. The thickness of the negative-electrode active material layer formed in this manner is, for example, 5 to 300 μm.

As a solid electrolyte included in the solid electrolyte layer 205, a known solid electrolyte (e.g., inorganic solid electrolyte) may be used. As an inorganic solid electrolyte, a sulfide solid electrolyte, an oxide solid electrolyte, or the like may be used. As a sulfide solid electrolyte, for example, a mixture of Li₂S:P₂S₅ may be used.

In addition, as a constituent of the solid electrolyte layer 205, a binder (e.g., polyvinylidene fluoride) or the like may be used.

These constituents may be kneaded with a solvent to obtain a coating material in the form of a paste, and the coating material may be applied onto the positive-electrode active material layer or the negative-electrode active material layer and dried, thereby forming the solid electrolyte layer 205.

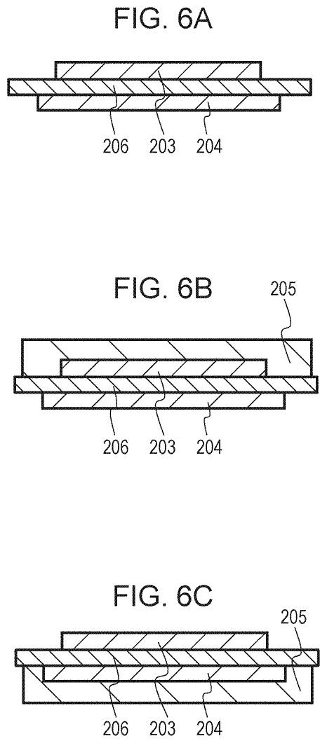

FIG. 5 is a cross-sectional view of a general configuration of another example of the power generation element 200 according to the first embodiment.

The power generation element 200 according to the first embodiment may be a stacked battery in which a plurality of battery cells are stacked as illustrated in FIG. 5.

The power generation element 200 illustrated in FIG. 5 includes the first current collector 201, the second current collector 202, first active material layers (203a, 203b, 203c), second active material layers (204a, 204b, 204c), solid electrolyte layers (205a, 205b, 205c), and bipolar current collectors 206.

In the power generation element 200 illustrated in FIG. 5, at portions other than the upper and lower ends of the power generation element 200, the bipolar current collectors 206 serve as both a positive-electrode current collector and a negative-electrode current collector.

Each of the current collectors at the upper and lower ends of the power generation element 200 is bonded to a corresponding one of a positive-electrode active material layer and a negative-electrode active material layer.

With the structure illustrated in FIG. 5, a high-voltage power-generation-element unit in which the power generation elements are connected in series can be obtained.

The order for forming these layers in the manufacturing process is not limited to a particular order. For example, sequential stacking, bonding, and transferring may be employed in combination.

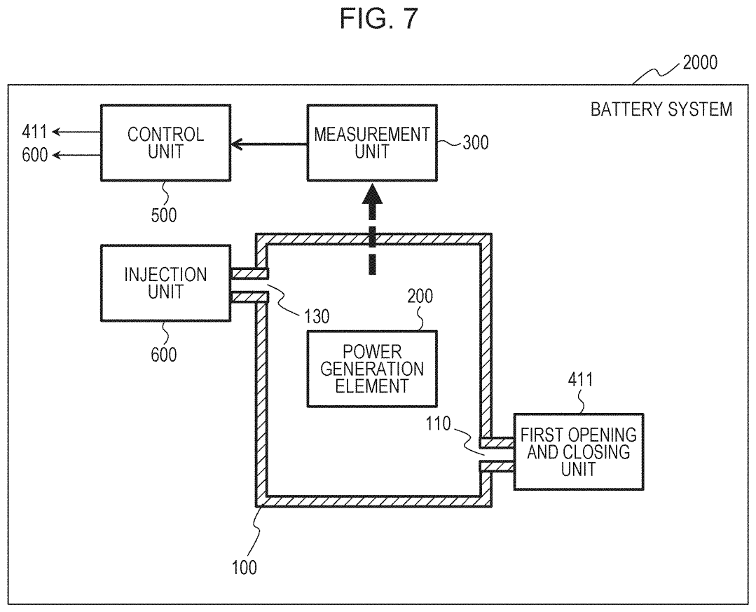

FIGS. 6A to 6C are cross-sectional views of stacking units in the power generation element 200 according to the first embodiment.

As illustrated in FIG. 6A, a bipolar current collector 206 has a positive-electrode current-collector face and a negative-electrode current-collector face on both sides. The positive-electrode active material layer is bonded to the positive-electrode current-collector face, and the negative-electrode active material layer is bonded to the negative-electrode current-collector face.

The bipolar current collector 206 may be a metal foil. Alternatively, the bipolar current collector 206 may be a metal foil formed of different materials on both sides. Still alternatively, the bipolar current collector 206 may be formed of two metal foils that overlap each other. Further alternatively, the bipolar current collector 206 may have any other structure as long as the upper and lower power generation elements can be electrically connected to each other.

As illustrated in FIG. 6B or 6C, a bipolar stacking unit is obtained by forming a positive-electrode active material layer, a negative-electrode active material layer, and a solid electrolyte layer on both sides of the bipolar current collector 206.

On either the upper end or the lower end of the bipolar stacking unit or a stacked body obtained by stacking bipolar stacking units, a positive-electrode current collector on which a positive-electrode active material layer is formed or a positive-electrode current collector on which a positive-electrode active material layer and a solid electrolyte layer are formed is stacked. On the other of the upper end and the lower end of the bipolar stacking unit or the stacked body, a negative-electrode current collector on which a negative-electrode active material layer and a solid electrolyte layer are formed or a negative-electrode current collector on which a negative-electrode active material layer is formed is stacked. Thus, the power generation element 200 illustrated in FIG. 5 can be obtained.

The positive-electrode active material layer and the negative-electrode active material layer face each other with the solid electrolyte layer interposed therebetween, and pressure is applied to the power generation element 200 in the stacking direction by a pressing machine. By the pressure being applied, each layer can be dense and can be bonded in a satisfactory state.

Note that in the power generation element 200 according to the first embodiment, the number of bipolar stacking units is not limited to a particular number. For example, the number of bipolar stacking units may be three or more.

Note that the power generation element 200 may be contained in a sealing case to be stored in the container 100. By using a sealing case, more stable operation of the battery system can be realized. Note that a laminated bag, a metal can, a resin case, or the like may be used as the sealing case. Alternatively, the power generation element 200 may be stored in the container 100 without a sealing case.

Note that in the first embodiment, the power generation element 200 may be a battery module in which a plurality of battery cells are connected in series or in parallel.

Alternatively, the power generation element 200 may be a battery pack in which a plurality of battery modules are connected in series or in parallel.

Still alternatively, the power generation element 200 may be a large battery in which a plurality of battery packs are connected in series or in parallel.

### Second Embodiment

Now, a second embodiment will be described below. A repeated description of the above-described first embodiment will be omitted as appropriate.

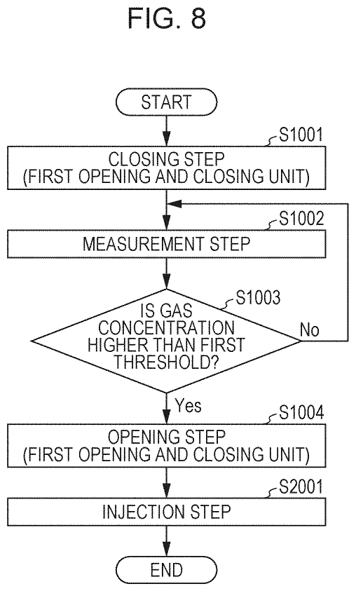

FIG. 7 illustrates a general configuration of a battery system 2000 according to the second embodiment.

The battery system 2000 according to the second embodiment further includes the following configuration in addition to the above-described configuration of the battery system 1000 according to the first embodiment.

That is, the battery system 2000 according to the second embodiment further includes an injection unit 600.

The container 100 includes an inlet 130.

The injection unit 600 injects a reference gas into the inside of the container 100 through the inlet 130.

The control unit 500 controls the injection unit 600.

After the first opening and closing unit 411 has been set to an open state, the control unit 500 causes the injection unit 600 to inject the reference gas into the inside of the container 100 through the inlet 130.

With the above configuration, the reference gas can be injected while the first opening and closing unit 411 is in an open state. Thus, the gas inside the container 100 can be replaced with the reference gas. Accordingly, the gas inside the container 100 can be discharged more reliably.

In addition, with the above configuration, after the gas has been discharged, the reference gas can be remained (kept present) inside the container 100. Thus, for example, the atmosphere of the space inside the container 100 can be set to a state close to the reference gas. Accordingly, the gas can be detected with a higher sensitivity inside the container 100 whose atmosphere is the reference gas. Therefore, the generated amount of the gas (gas concentration) can be obtained more accurately.

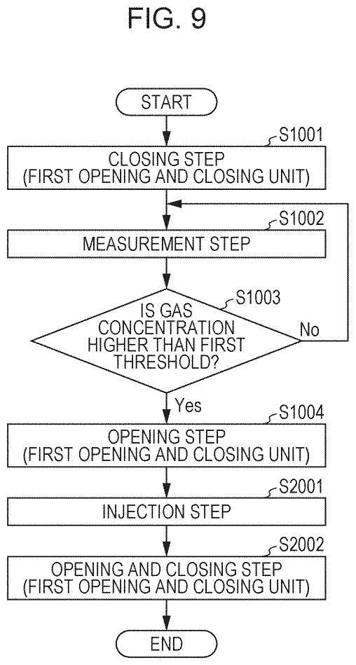

FIG. 8 is a flowchart illustrating an exemplary control method according to the second embodiment.

The control method illustrated in FIG. 8 further includes an injection step S2001 in addition to the above-described control method illustrated in FIG. 2.

In the injection step S2001, the injection unit 600 injects the reference gas into the inside of the container 100 through the inlet 130.

Note that the injection step S2001 may be started after the opening step S1004 as illustrated in FIG. 8. Alternatively, the injection step S2001 may be started before the opening step S1004 is performed (and after the determination step S1003).

The inlet 130 may be an opening provided on a side surface of the container 100 as illustrated in FIG. 7. Alternatively, the inlet 130 may be provided at a portion (e.g., corner) other than the side surface of the container 100. The shape of the inlet 130 may be circular, elliptic, rectangular, linear, or the like.

Note that in the battery system 2000 according to the second embodiment, the control unit 500 may open and close the first opening and closing unit 411 a plurality of times while the injection unit 600 injects the reference gas into the inside of the container 100 through the inlet 130.

With the above configuration, for example, the discharge of the gas and the injection of the reference gas can be alternately repeated a plurality of times. Thus, the atmosphere inside the container 100 can be returned to a state closer to the reference gas again. That is, the atmosphere inside the container 100 can be maintained in a state of being filled with the reference gas. As a result, the high sensitivity for gas detection can be maintained. Accordingly, the battery can be operated more safely.

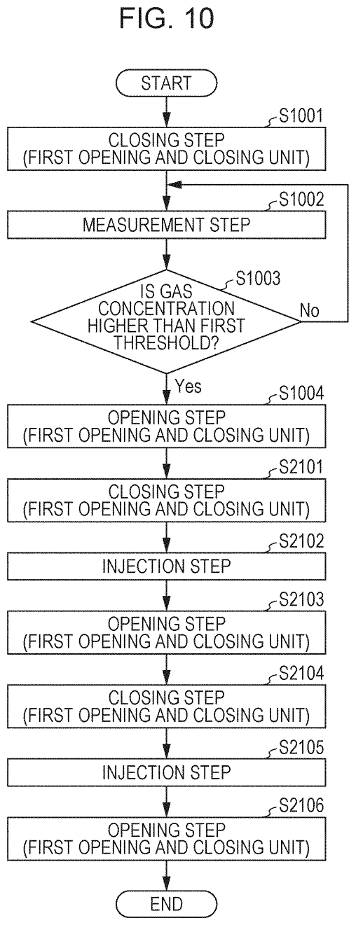

FIG. 9 is a flowchart illustrating an exemplary control method according to the second embodiment.

The control method illustrated in FIG. 9 further includes an opening and closing step S2002 in addition to the above-described control method illustrated in FIG. 8.

In the opening and closing step S2002, the control unit 500 opens and closes the first opening and closing unit 411 a plurality of times.

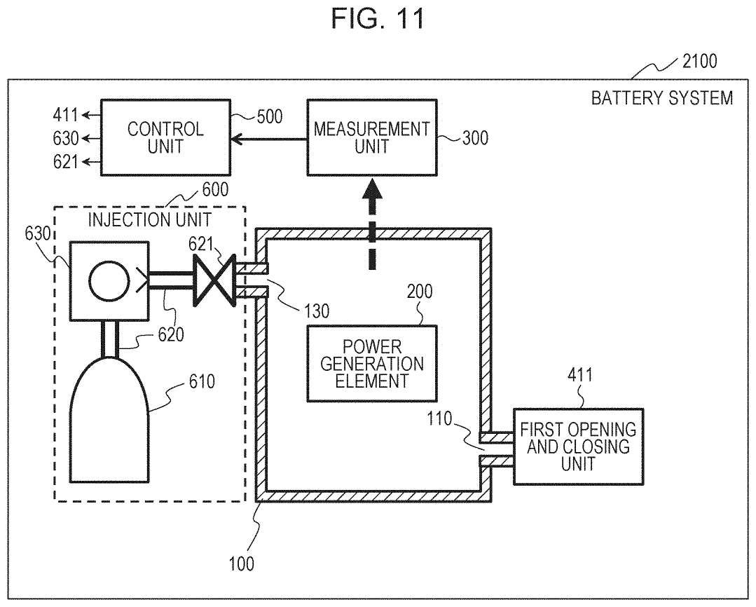

FIG. 10 is a flowchart illustrating an exemplary control method according to the second embodiment.

The control method illustrated in FIG. 10 further includes the following steps in addition to the above-described control method illustrated in FIG. 9.

That is, the control method illustrated in FIG. 10 includes, instead of the injection step S2001 and the opening and closing step S2002 in the above-described control method illustrated in FIG. 9, a closing step S2101, an injection step S2102, an opening step S2103, a closing step S2104, an injection step S2105, and an opening step S2106.

In the closing step S2101 and the closing step S2104, the control unit 500 sets the first opening and closing unit 411 to a closed state.

In the injection step S2102 and the injection step S2105, the injection unit 600 injects the reference gas into the inside of the container 100 through the inlet 130.

In the opening step S2103 and the opening step S2106, the control unit 500 sets the first opening and closing unit 411 to an open state.

With the above configuration, for example, the discharge of the gas and the injection of the reference gas can be alternately repeated a plurality of times. Thus, the atmosphere inside the container 100 can be returned to a state closer to the reference gas again.

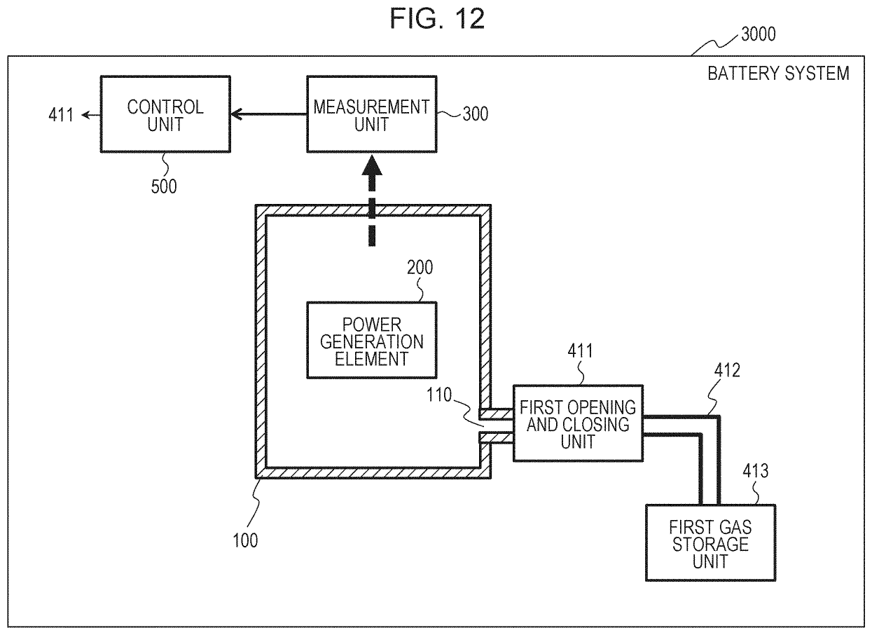

FIG. 11 illustrates a general configuration of a battery system 2100 according to the second embodiment.

The battery system 2100 according to the second embodiment further includes the following configuration in addition to the above-described configuration of the battery system 2000 according to the second embodiment.

That is, the injection unit 600 in the battery system 2100 according to the second embodiment includes a reference gas source 610, an injection path 620, and an injection assistance unit 630.

The reference gas is supplied from the reference gas source 610.

A first end of the injection path 620 is connected to the reference gas source 610.

A second end of the injection path 620 is connected to the inlet 130.

The control unit 500 makes the pressure of the injection path 620 a positive pressure with respect to the pressure inside the container 100 by using the injection assistance unit 630.

With the above configuration, the internal pressure of the injection path 620 can be made higher than the internal pressure of the container 100. Thus, when the inlet 130 is open, the reference gas can be forcibly injected from the injection path 620 into the inside of the container 100. Accordingly, the reference gas can be injected into the inside of the container 100 more efficiently.

For example, the reference gas source 610 may be a storage unit (e.g., tank or cylinder) in which the reference gas is stored in advance. Alternatively, the reference gas source 610 may be an apparatus that generates the reference gas.

The injection path 620 may be, for example, a hollow pipe-like member (e.g., pipe) or the like. The injection path 620 may have a typically known pipe structure.

Note that the injection path 620 may include an inlet opening and closing unit 621. For example, as illustrated in FIG. 11, the inlet opening and closing unit 621 may be provided to be connected between the second end of the injection path 620 and the inlet 130.

For example, as illustrated in FIG. 11, the inlet opening and closing unit 621 may be a valve (e.g., control valve). In this case, the valve is controlled to be open and closed in accordance with a control signal from the control unit 500, and thereby the inlet opening and closing unit 621 may be open and closed.

That is, while the inlet opening and closing unit 621 (valve) is in a closed state, the reference gas supplied from the reference gas source 610 cannot move to the inside of the container 100 through the injection path 620 and the inlet 130 (and the inlet opening and closing unit 621).

On the other hand, while the inlet opening and closing unit 621 (valve) is in an open state, the reference gas supplied from the reference gas source 610 can move to the inside of the container 100 through the injection path 620 and the inlet 130 (and the inlet opening and closing unit 621).

For example, the injection assistance unit 630 may be a pump. That is, the injection assistance unit 630 may be an apparatus that assists the injection of the reference gas by adjusting the internal pressure of the injection path 620 in accordance with a control signal from the control unit 500.

As illustrated in FIG. 11, the injection assistance unit 630 may be connected to the injection path 620. That is, the injection assistance unit 630 may be disposed on a path that connects the reference gas source 610 to the inlet 130.

The control unit 500 may control the inlet opening and closing unit 621 and the injection assistance unit 630. For example, the control unit 500 may set the inlet opening and closing unit 621 to a closed state while making the pressure of the injection path 620 to be a positive pressure with respect to the pressure inside the container 100 by using the injection assistance unit 630.

Note that the reference gas may be a dehumidified gas or an inert gas.

With the above configuration, in the container 100 whose atmosphere is a dehumidified gas or an inert gas, the gas can be detected with a higher sensitivity while avoiding a reaction between the reference gas and the power generation element 200.

Note that the reference gas may be an atmosphere gas in the space inside the container 100 at an initial state of the battery system.

### Third Embodiment

Now, a third embodiment will be described below. A repeated description of the above-described first or second embodiment will be omitted as appropriate.

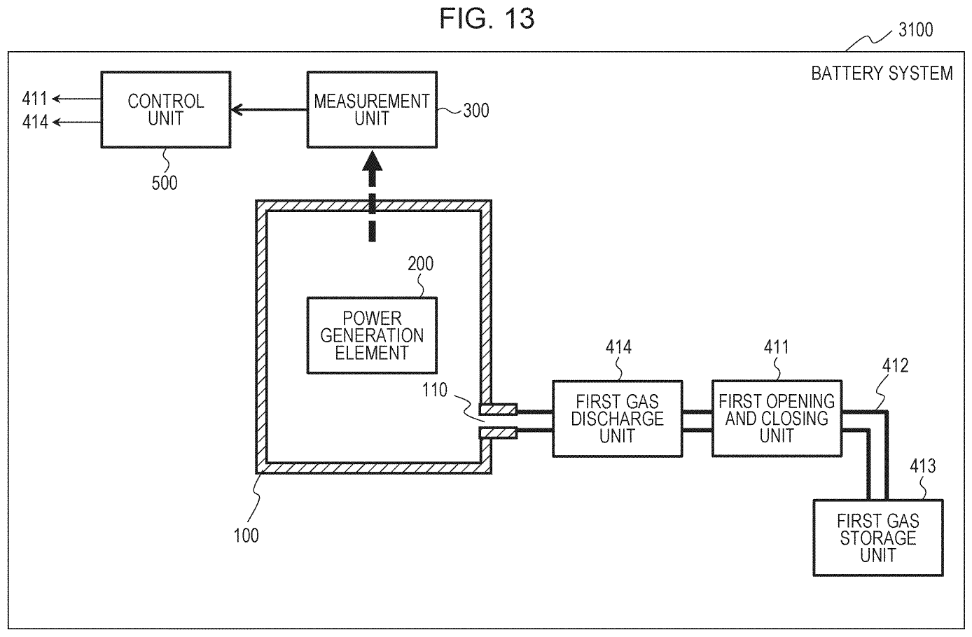

FIG. 12 illustrates a general configuration of a battery system 3000 according to the third embodiment.

The battery system 3000 according to the third embodiment further includes the following configuration in addition to the above-described configuration of the battery system 1000 according to the first embodiment.

That is, the battery system 3000 according to the third embodiment further includes the first discharge path 412 and a first gas storage unit 413.

A first end of the first discharge path 412 is connected to the first opening and closing unit 411.

A second end of the first discharge path 412 is connected to the first gas storage unit 413.

With the above configuration, the gas that is discharged from the inside of the container 100 through the first outlet 110 can be stored in the first gas storage unit 413. Thus, the gas (e.g., poisonous gas) generated inside the container 100 can be prevented from being released to the air. Thus, the battery can be stably operated without diffusing the gas.

The first discharge path 412 may be, for example, a hollow pipe-like member (e.g., pipe) or the like. The first discharge path 412 may have a typically known pipe structure.

The first gas storage unit 413 may be a storage unit (e.g., tank) including a space to be capable of storing the gas that is discharged. Alternatively, the first gas storage unit 413 may be an apparatus including a substance (e.g., absorbent) that absorbs the gas that is discharged.

Note that in a case in which the first gas storage unit 413 is a storage unit (e.g., tank) including a space, a check valve may be provided at a position where the first gas storage unit 413 is connected to the first discharge path 412. Thus, the check valve can prevent a gas that is discharged to the first gas storage unit 413 from returning (flowing backward) to the first discharge path 412.

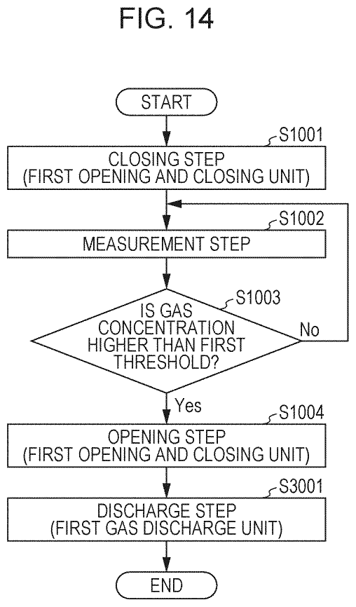

FIG. 13 illustrates a general configuration of a battery system 3100 according to the third embodiment.

The battery system 3100 according to the third embodiment further includes the following configuration in addition to the above-described configuration of the battery system 3000 in the third embodiment.

That is, the battery system 3100 according to the third embodiment further includes a first gas discharge unit 414.

The first gas discharge unit 414 discharges the gas inside the container 100 to the first gas storage unit 413 through the first outlet 110.

The control unit 500 controls the first opening and closing unit 411 and the first gas discharge unit 414.

After the first opening and closing unit 411 has been set to an open state, the control unit 500 causes the first gas discharge unit 414 to discharge the gas to the first gas storage unit 413 through the first outlet 110.

With the above configuration, the gas that is discharged from the inside of the container 100 through the first outlet 110 can be stored in the first gas storage unit 413 more reliably and in a shorter period of time. Thus, the gas generated inside the container 100 can be prevented from being released to the air.

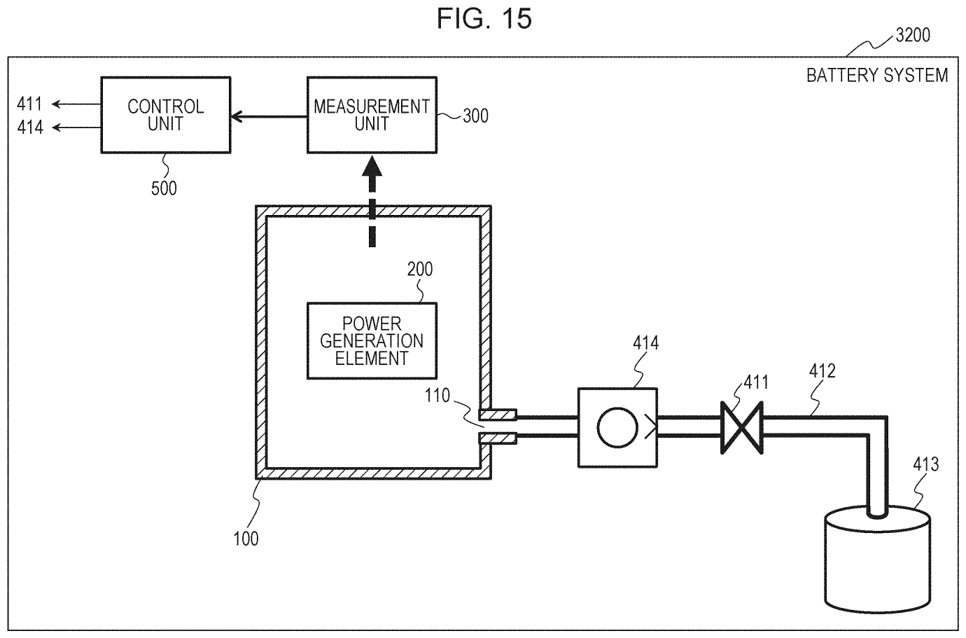

FIG. 14 is a flowchart illustrating an exemplary control method according to the third embodiment.

The control method illustrated in FIG. 14 further includes a discharge step S3001 in addition to the above-described control method illustrated in FIG. 2.

The discharge step S3001 is performed after the opening step S1004. In the discharge step S3001, the gas inside the container 100 is discharged by the first gas discharge unit 414 to the first gas storage unit 413 through the first outlet 110.

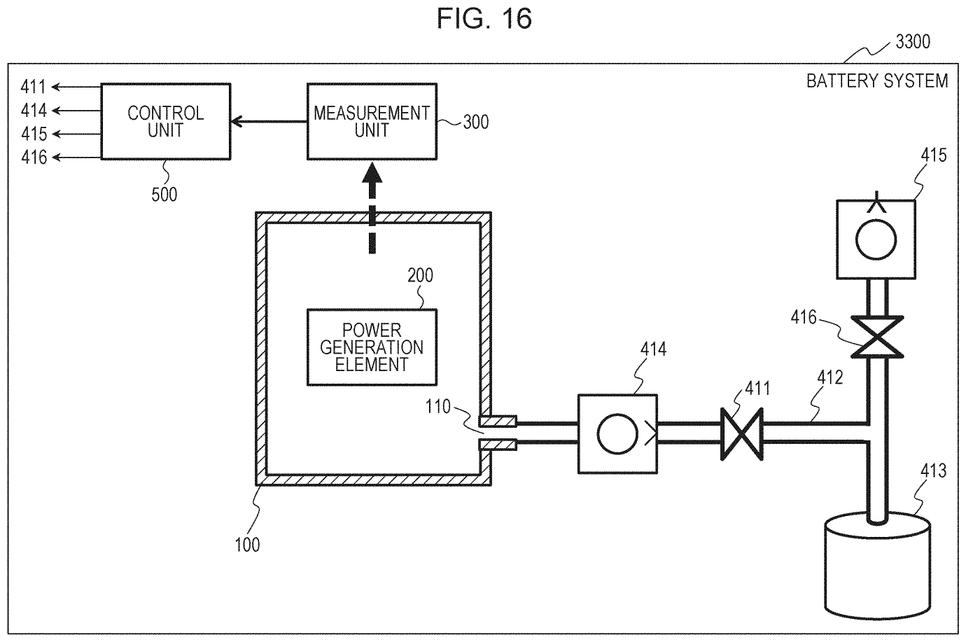

FIG. 15 illustrates a general configuration of a battery system 3200 according to the third embodiment.

In the third embodiment, for example, the first gas discharge unit 414 may be a pump as illustrated in FIG. 15. That is, the first gas discharge unit 414 may be an apparatus that assists the discharge of the gas inside the container 100 in accordance with a control signal from the control unit 500.

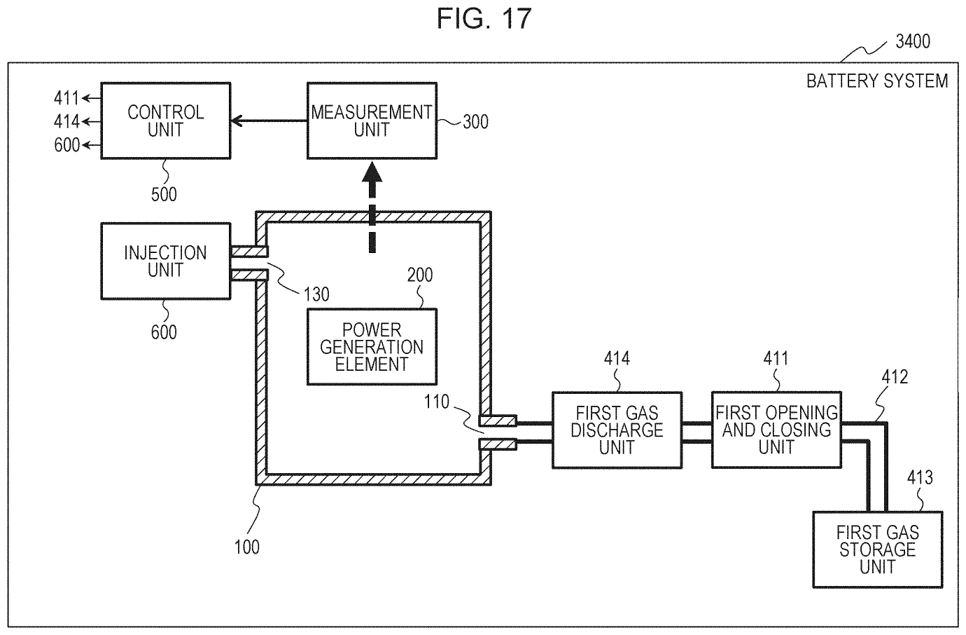

FIG. 16 illustrates a general configuration of a battery system 3300 according to the third embodiment.

The battery system 3300 according to the third embodiment further includes the following configuration in addition to the above-described configuration of the battery system 3200 according to the third embodiment.

That is, the battery system 3300 according to the third embodiment further includes a discharge assistance unit 415 and an opening and closing unit 416.

For example, the discharge assistance unit 415 may be a pump (vacuum pump). That is, the discharge assistance unit 415 may be an apparatus that assists the discharge by adjusting the internal pressure of the first discharge path 412 in accordance with a control signal from the control unit 500.

For example, as illustrated in FIG. 16, the opening and closing unit 416 may be a valve (e.g., control valve). In this case, the valve is controlled to be open and closed in accordance with a control signal from the control unit 500, and thereby the opening and closing unit 416 may be open and closed. In this case, while the opening and closing unit 416 is in a closed state, the discharge assistance unit 415 is not connected to the first discharge path 412. On the other hand, while the opening and closing unit 416 is in an open state, the discharge assistance unit 415 is connected to the first discharge path 412.

The control unit 500 in the battery system 3300 according to the third embodiment may control the first opening and closing unit 411, the first gas discharge unit 414, the discharge assistance unit 415, and the opening and closing unit 416.

Note that the opening and closing unit 416 may be set to a closed state while the gas inside the container 100 is discharged by the first gas discharge unit 414 to the first gas storage unit 413 through the first outlet 110 (the discharge step S3001).

Note that in the third embodiment, the first gas storage unit 413 may be a first gas storage tank as illustrated in FIG. 16.

In this case, the control unit 500 may make the pressure inside the first gas storage tank a negative pressure (reduced pressure) with respect to the pressure inside the container 100 by using the discharge assistance unit 415 (for example, while the first opening and closing unit 411 is in a closed state and the opening and closing unit 416 is in an open state).

With the above configuration, the internal pressure of the first gas storage tank can be made lower than the internal pressure of the container 100. Thus, when the first opening and closing unit 411 is open, the gas can be forcibly discharged from the inside of the container 100 to the first gas storage tank. Accordingly, the first gas storage tank can store the gas more efficiently.

Note that in the third embodiment, the control unit 500 may make the pressure inside the container 100 a negative pressure with respect to the pressure outside the container 100 by using the discharge assistance unit 415 (for example, while the first opening and closing unit 411 and the opening and closing unit 416 are in an open state).

With the above configuration, the internal pressure of the container 100 can be made lower than the air pressure (e.g., atmospheric pressure) outside the container 100. Thus, the risk of diffusing the gas from the container 100 to the air can be further reduced.

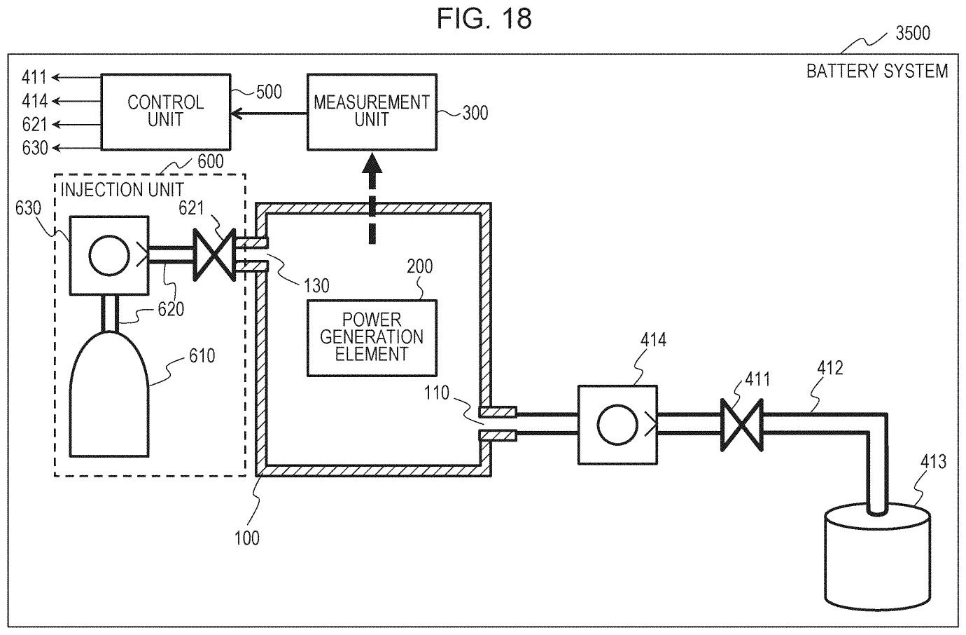

FIG. 17 illustrates a general configuration of a battery system 3400 according to the third embodiment.

The battery system 3400 according to the third embodiment further includes the above-described configuration of the battery system 2000 according to the second embodiment, in addition to the above-described configuration of the battery system 3100 according to the third embodiment.

That is, the battery system 3400 according to the third embodiment includes both the first gas discharge unit 414 and the injection unit 600.

The control unit 500 in the battery system 3400 according to the third embodiment controls the first opening and closing unit 411, the first gas discharge unit 414, and the injection unit 600.

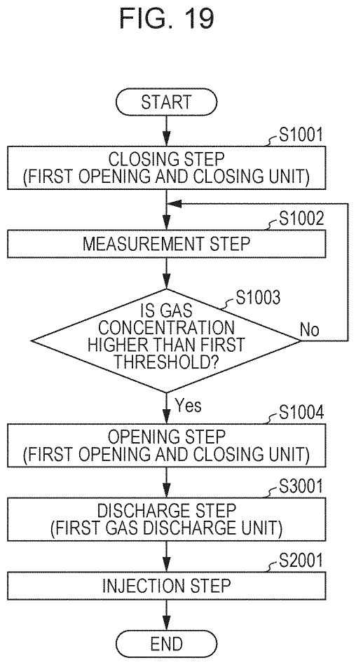

FIG. 18 illustrates a general configuration of a battery system 3500 according to the third embodiment.

The battery system 3500 according to the third embodiment further includes the above-described configuration of the battery system 2100 according to the second embodiment, in addition to the above-described configuration of the battery system 3300 according to the third embodiment.

The control unit 500 in the battery system 3500 according to the third embodiment controls the first opening and closing unit 411, the first gas discharge unit 414, the inlet opening and closing unit 621, and the injection assistance unit 630.

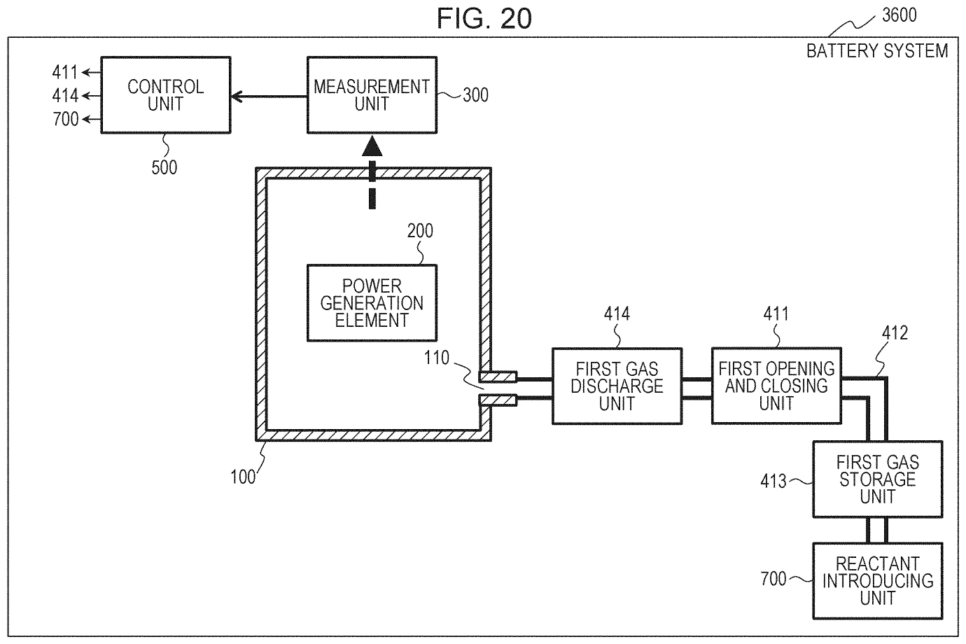

FIG. 19 is a flowchart illustrating an exemplary control method according to the third embodiment.

The control method illustrated in FIG. 19 further includes the above-described injection step S2001 illustrated in FIG. 8, in addition to the above-described control method illustrated in FIG. 14.

According to the battery system 3400, the battery system 3500, or the control method illustrated in FIG. 19, the first gas discharge unit 414 can discharge the gas, and the injection unit 600 can inject the reference gas at the same time. Thus, the gas inside the container 100 can be replaced with the reference gas more efficiently and in a shorter period of time. Accordingly, the gas can be discharged from the inside of the container 100 more reliably.

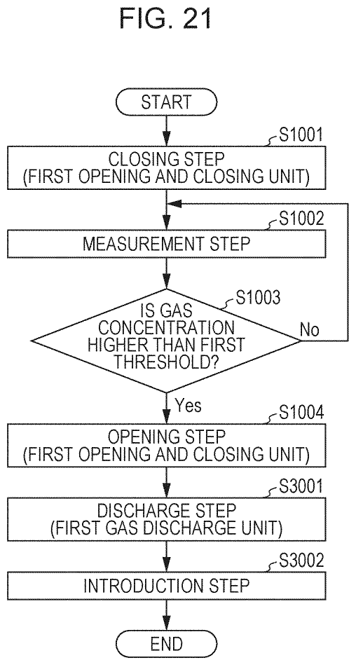

FIG. 20 illustrates a general configuration of a battery system 3600 according to the third embodiment.

The battery system 3600 according to the third embodiment further includes the following configuration in addition to the above-described configuration of the battery system 3100 according to the third embodiment.

That is, the battery system 3600 according to the third embodiment further includes a reactant introducing unit 700.

The reactant introducing unit 700 introduces a reactant that reacts with the gas into the first gas storage unit 413.

The control unit 500 controls the first opening and closing unit 411, the first gas discharge unit 414, and the reactant introducing unit 700.

After the first gas discharge unit 414 has discharged the gas to the first gas storage unit 413 through the first outlet 110, the control unit 500 causes the reactant introducing unit 700 to introduce the reactant into the first gas storage unit 413.

With the above configuration, after the gas has been discharged to the first gas storage unit 413, the reactant can be introduced into the first gas storage unit 413. Thus, unlike in a configuration in which the reactant is disposed in advance in the first gas storage unit 413, it is possible to prevent the reduced pressure state inside the first gas storage unit 413 from being lost by the reactant when the gas is discharged to the first gas storage unit 413. Accordingly, while the gas is forcibly discharged to the first gas storage unit 413, the gas can react with the reactant in the first gas storage unit 413. That is, the gas can be made harmless by using the reactant in the first gas storage unit 413. Therefore, the danger of the gas (e.g., poisonous gas) can be reduced, and thereby, for example, it is possible to prevent a decrease in safety resulting from gas leakage from the first gas storage unit 413.

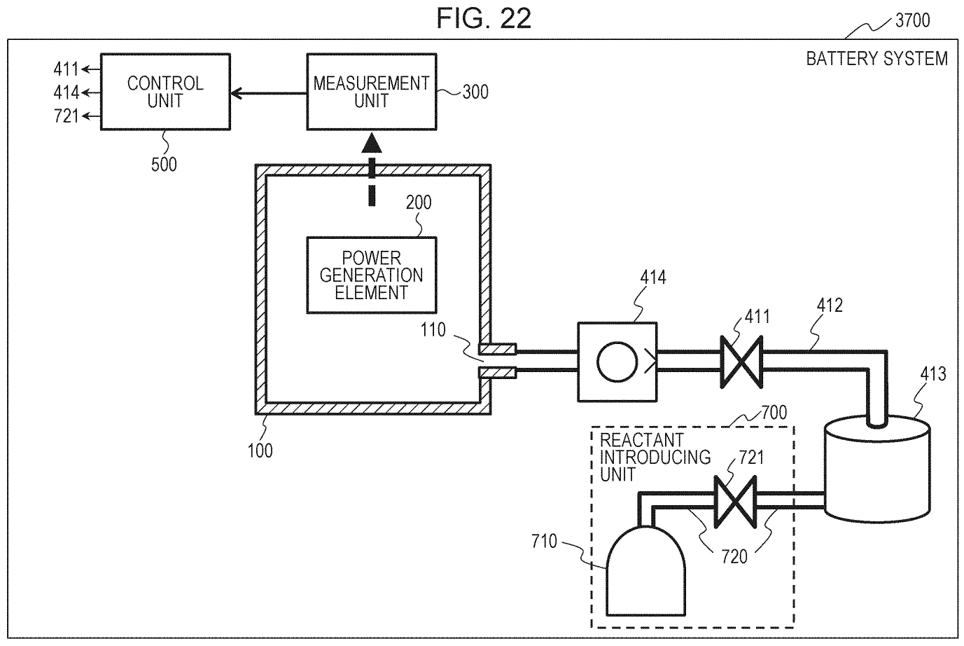

FIG. 21 is a flowchart illustrating an exemplary control method according to the third embodiment.

The control method illustrated in FIG. 21 further includes an introduction step S3002 in addition to the above-described control method illustrated in FIG. 14.

In the introduction step S3002, the reactant introducing unit 700 introduces the reactant into the first gas storage unit 413.

Note that in the third embodiment, the reactant may be, for example, a material that makes the gas, which is the discharge target, harmless as a result of a chemical reaction with the gas, which is the discharge target. Alternatively, the reactant may be, for example, a material that makes the gas, which is the discharge target, harmless by absorbing the gas, which is the discharge target.

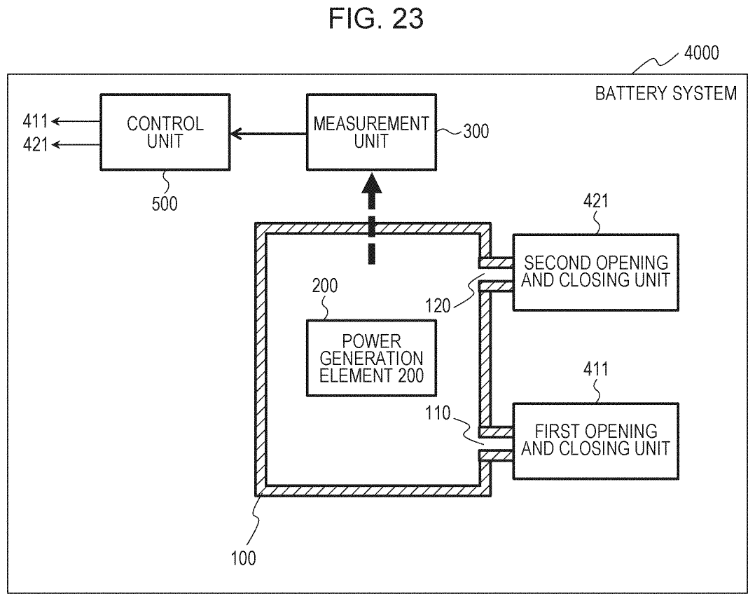

FIG. 22 illustrates a general configuration of a battery system 3700 according to the third embodiment.

The battery system 3700 according to the third embodiment further includes the following configuration in addition to the configuration of the battery system 3600 according to the third embodiment.

That is, the reactant introducing unit 700 in the battery system 3700 according to the third embodiment includes a reactant source 710, an introduction path 720, and an opening and closing unit 721.

The reactant is supplied from the reactant source 710. For example, the reactant source 710 may be a storage unit (e.g., tank or cylinder) in which the reactant is stored in advance. Alternatively, the reactant source 710 may be an apparatus that generates the reactant.

A first end of the introduction path 720 is connected to the reactant source 710. A second end of the introduction path 720 is connected to the first gas storage unit 413.

The introduction path 720 may be, for example, a hollow pipe-like member (e.g., pipe) or the like. The introduction path 720 may have a typically known pipe structure.

Note that the introduction path 720 may include the opening and closing unit 721. For example, as illustrated in FIG. 22, the opening and closing unit 721 may be provided in a path connecting the reactant source 710 to the first gas storage unit 413.

For example, as illustrated in FIG. 22, the opening and closing unit 721 may be a valve (e.g., control valve). In this case, the valve is controlled to be open and closed in accordance with a control signal from the control unit 500, and thereby the opening and closing unit 721 may be open and closed.

That is, while the opening and closing unit 721 (valve) is in a closed state, the reactant supplied from the reactant source 710 is not introduced into the inside of the first gas storage unit 413 through the introduction path 720 (and the opening and closing unit 721).

On the other hand, while the opening and closing unit 721 (valve) is in an open state, the reactant supplied from the reactant source 710 is introduced into the inside of the first gas storage unit 413 through the introduction path 720 (and the opening and closing unit 721).

The control unit 500 in the battery system 3700 according to the third embodiment may control the first opening and closing unit 411, the first gas discharge unit 414, and the opening and closing unit 721.

Note that in the third embodiment, the first gas storage unit 413 may include the reactant that reacts with the gas. That is, for example, if the first gas storage unit 413 is a first gas storage tank, the reactant may be provided in advance inside the first gas storage tank.

With the above configuration, the gas can be made harmless by using the reactant in the first gas storage unit 413. Therefore, the danger of the gas (e.g., poisonous gas) can be reduced, and thereby, for example, it is possible to prevent a decrease in safety resulting from gas leakage from the first gas storage unit 413.

Note that in the third embodiment, the power generation element 200 may include a sulfide-based material (e.g., sulfide solid electrolyte).

In this case, the gas may be hydrogen sulfide generated from the sulfide-based material. For example, hydrogen sulfide may be generated as a result of a reaction between a sulfide solid electrolyte and moisture.

In this case, the reactant may be at least one selected from the group consisting of sodium hydroxide, sodium carbonate, a copper(II) sulfate aqueous solution, and hydrogen peroxide.

With the above configuration, for example, a battery including the power generation element 200 in which a sulfide-based material that may generate hydrogen sulfide is used can be used safely. Thus, for example, a solid-state battery including a sulfide solid electrolyte, which is a sulfide-based material, in an electrolyte layer can be used safely.

The above-described reactant and hydrogen sulfide react as follows.
<if sodium hydroxide is used> 2NaOH+H₂S→Na₂S+2H₂O
<if sodium carbonate if used> Na₂CO₃+H2S→Na₂S+CO₂+H₂O
<if a copper(II) sulfate aqueous solution is used> Cu+H₂S→H₂+CuS
<if hydrogen peroxide is used> H₂O₂+H₂S→2H₂O+S
   With the above reaction, the danger of the hydrogen sulfide gas can be reduced.

### Fourth Embodiment

Now, a fourth embodiment will be described below. A repeated description of any of the above-described first to third embodiments will be omitted as appropriate.

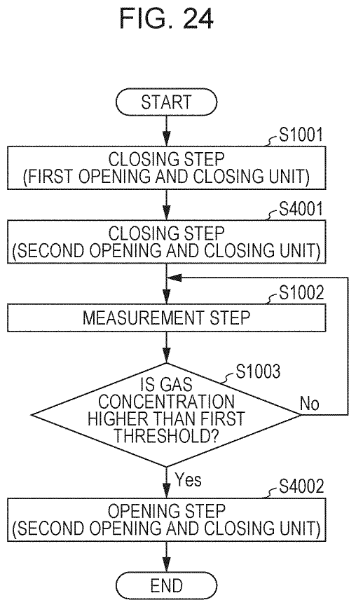

FIG. 23 illustrates a general configuration of a battery system 4000 according to the fourth embodiment.

The battery system 4000 according to the fourth embodiment further includes the following configuration in addition to the above-described configuration of the battery system 1000 according to the first embodiment.

That is, the battery system 4000 according to the fourth embodiment further includes a second opening and closing unit 421.

The container 100 includes a second outlet 120.

The second opening and closing unit 421 is connected to the second outlet 120.

The control unit 500 controls the first opening and closing unit 411 and the second opening and closing unit 421.

After a gas concentration has exceeded the first threshold, the control unit 500 sets the second opening and closing unit 421 to an open state.

The gas concentration here is a concentration measured by the measurement unit 300 while the first opening and closing unit 411 and the second opening and closing unit 421 are in a closed state.

With the above configuration, the path for discharging the gas can be switched. That is, by controlling the first opening and closing unit 411 and the second opening and closing unit 421, it is possible to select the first outlet 110 or the second outlet 120 as a part of the path for discharging the gas.

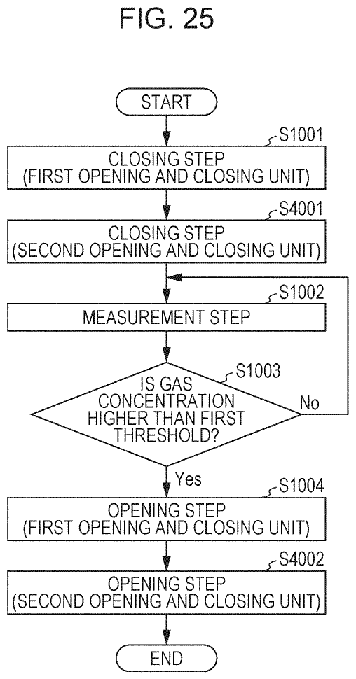

FIG. 24 is a flowchart illustrating an exemplary control method according to the fourth embodiment.

The control method illustrated in FIG. 24 further includes a closing step S4001 in addition to the above-described control method illustrated in FIG. 2. In addition, the control method illustrated in FIG. 24 includes an opening step S4002 instead of the above-described opening step S1004 in the control method illustrated in FIG. 2.

In the closing step S4001, the control unit 500 sets the second opening and closing unit 421 to a closed state.

In the measurement step S1002, the measurement unit 300 measures the gas concentration while the first opening and closing unit 411 and the second opening and closing unit 421 are in a closed state.

In the determination step S1003, if it is determined that the gas concentration is higher than the first threshold, the opening step S4002 is performed.

The opening step S4002 is performed after the determination step S1003. In the opening step S4002, the control unit 500 sets the second opening and closing unit 421 to an open state.

With the above control method, after the gas concentration has exceeded the first threshold, while the first opening and closing unit 411 is in a closed state, the second opening and closing unit 421 can be set to an open state.

Note that the closing step S4001 may be performed after the closing step S1001 or before the closing step S1001. Alternatively, the closing step S1001 and the closing step S4001 may be performed at the same time.

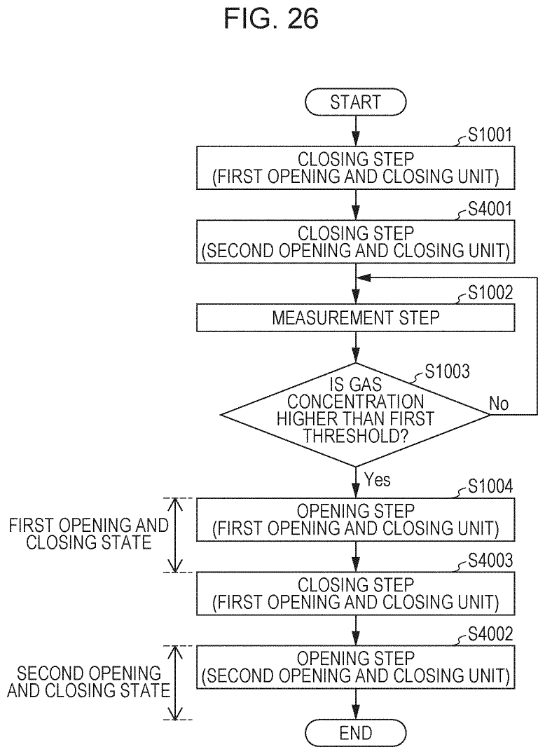

FIG. 25 is a flowchart illustrating an exemplary control method according to the fourth embodiment.

The control method illustrated in FIG. 25 further includes the opening step S1004 in addition to the above-described control method illustrated in FIG. 24.

According to the above control method, both the first opening and closing unit 411 and the second opening and closing unit 421 can be set to an open state. Thus, for example, if the first gas storage unit 413 is connected to the first opening and closing unit 411 and an external apparatus (e.g., purifying apparatus, gas analyzing apparatus, or warning apparatus) is connected to the second opening and closing unit 421, the gas can be discharged to and stored in the first gas storage unit 413 connected to the first opening and closing unit 411. At the same time, part of the gas can also be supplied to the external apparatus connected to the second opening and closing unit 421. Accordingly, the safety of the battery system can be further increased.

Note that the opening step S4002 may be performed after the opening step S1004 or before the opening step S1004. Alternatively, the opening step S1004 and the opening step S4002 may be performed at the same time.

Note that after the gas concentration (i.e., the gas concentration inside the container 100 measured by the measurement unit 300 while the first opening and closing unit 411 and the second opening and closing unit 421 are in a closed state) has exceeded the first threshold, the control unit 500 in the battery system 4000 according to the fourth embodiment may control the first opening and closing unit 411 and the second opening and closing unit 421 to generate a first opening-and-closing-state and a second opening-and-closing-state.

In the first opening-and-closing-state, the first opening and closing unit 411 is set to an open state, and the second opening and closing unit 421 is set to a closed state.

In the second opening-and-closing-state, the first opening and closing unit 411 is set to a closed state, and the second opening and closing unit 421 is set to an open state.

With the above configuration, the path for discharging the gas can be switched. That is, for example, the time for generating the first opening-and-closing-state and the second opening-and-closing-state is adjusted, and thereby the amount of gas to be discharged through the first outlet 110 (e.g., discharged to the first gas storage unit 413) and the amount of gas to be discharged through the second outlet 120 (e.g., discharged to a second gas storage unit 423, which will be described later) can be adjusted. In this case, for example, the gas can be collected in a state in which the first gas storage unit 413 and the second gas storage unit 423 store the gas at different gas concentration levels. As a result, the collected gas can be processed by a method in accordance with the corresponding gas concentration level. Accordingly, the cost for processing the collected gas can be reduced, and the processing steps can be simplified.

In addition, according to the above configuration, for example, if the first gas storage unit 413 is connected to the first opening and closing unit 411 and an external apparatus (e.g., purifying apparatus, gas analyzing apparatus, or warning apparatus) is connected to the second opening and closing unit 421, most of the discharged gas can be stored in the first gas storage unit 413 in a certain period of time, and part of the discharged gas can be supplied to the external apparatus in a different period of time. Accordingly, the safety of the battery system can be further increased.

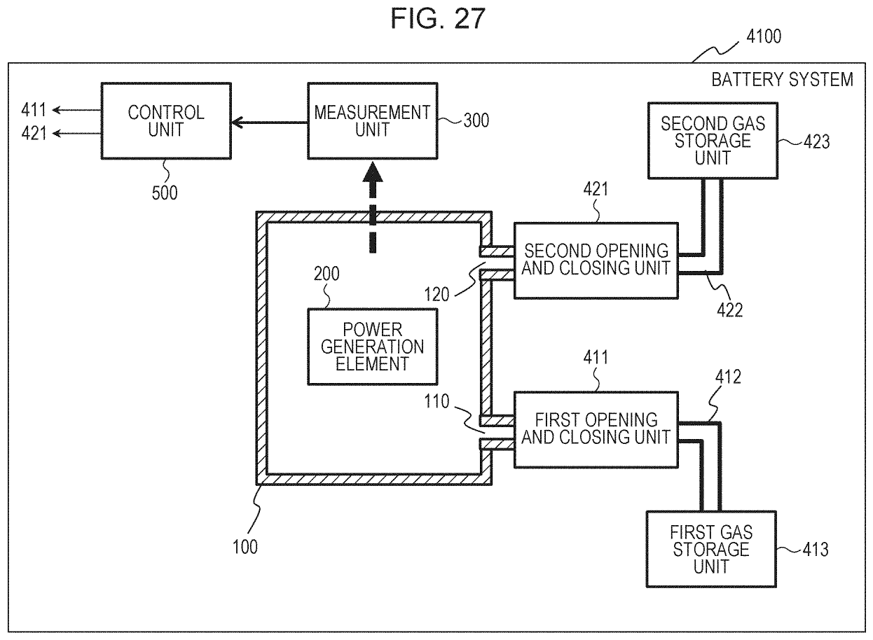

FIG. 26 is a flowchart illustrating an exemplary control method according to the fourth embodiment.

The control method illustrated in FIG. 26 further includes a closing step S4003 performed between the opening step S1004 and the opening step S4002, in addition to the above-described control method illustrated in FIG. 25.

In the closing step S4003, the control unit 500 sets the first opening and closing unit 411 to a closed state.

With the above control method, the second opening-and-closing-state can be generated after the first opening-and-closing-state has been generated.

Note that the first opening-and-closing-state may be generated after the second opening-and-closing-state has been generated. In addition, the first opening-and-closing-state and the second opening-and-closing-state may be alternately generated a plurality of times.

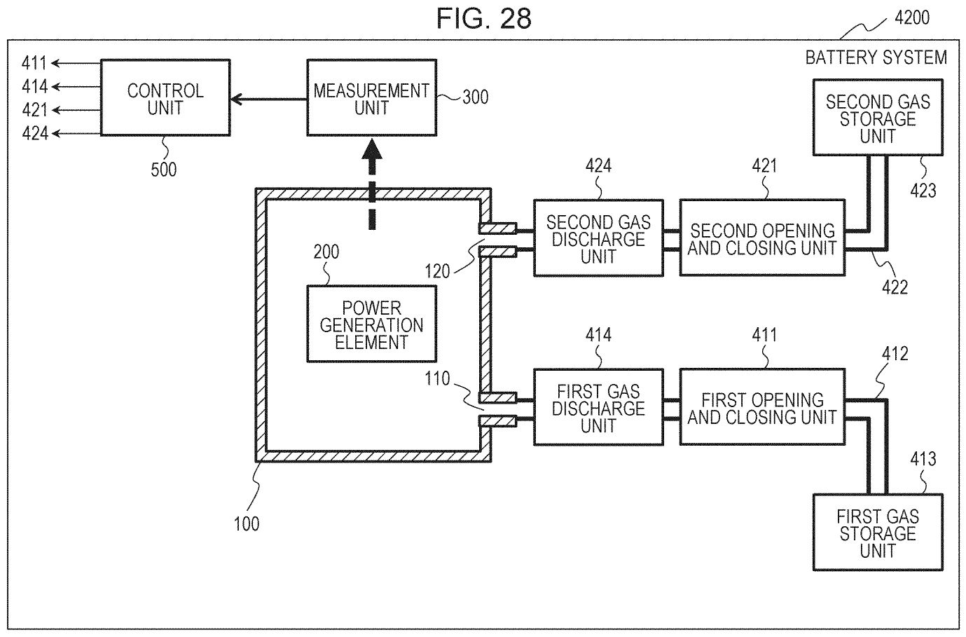

FIG. 27 illustrates a general configuration of a battery system 4100 according to the fourth embodiment.

The battery system 4100 according to the fourth embodiment further includes the configuration of the battery system 3000 according to the third embodiment and the following configuration, in addition to the above-described configuration of the battery system 4000 according to the fourth embodiment.

That is, the battery system 4100 according to the fourth embodiment further includes a second discharge path 422 and the second gas storage unit 423.

A first end of the second discharge path 422 is connected to the second opening and closing unit 421.

A second end of the second discharge path 422 is connected to the second gas storage unit 423.

With the above configuration, among a plurality of gas storage units connected to the container 100, a gas storage unit that discharges the gas and a gas storage unit that stores the gas can be switched. Thus, for example, in a state in which it is not possible to discharge the gas to, and to store the gas in, the first gas storage unit 413 (e.g., while the first gas storage unit 413 is being detached from the first discharge path 412), even if the gas concentration inside the container 100 exceeds the first threshold, the gas can be discharged to and stored in the second gas storage unit 423 through the second opening and closing unit 421 that is in an open state and the second discharge path 422. Accordingly, the battery system can be operated more safely.

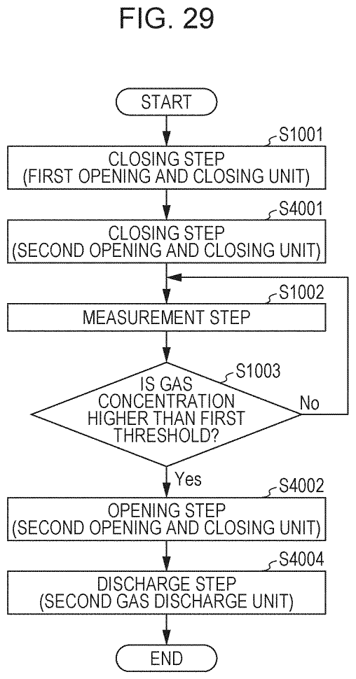

FIG. 28 illustrates a general configuration of a battery system 4200 according to the fourth embodiment.

The battery system 4200 according to the fourth embodiment includes the configuration of the battery system 3100 according to the third embodiment and the following configuration, in addition to the above-described configuration of the battery system 4100 according to the fourth embodiment.

That is, the battery system 4200 according to the fourth embodiment further includes a second gas discharge unit 424.

The second gas discharge unit 424 discharges the gas inside the container 100 to the second gas storage unit 423 through the second outlet 120.

The control unit 500 controls the first opening and closing unit 411, the first gas discharge unit 414, the second opening and closing unit 421, and the second gas discharge unit 424.

After the second opening and closing unit 421 has been set to an open state, the control unit 500 causes the second gas discharge unit 424 to discharge the gas to the second gas storage unit 423 through the second outlet 120.

With the above configuration, the gas that is discharged from the inside of the container 100 through the second outlet 120 can be stored in the second gas storage unit 423 more reliably and in a shorter period of time. Thus, the gas generated inside the container 100 can be prevented from being released to the air more reliably.

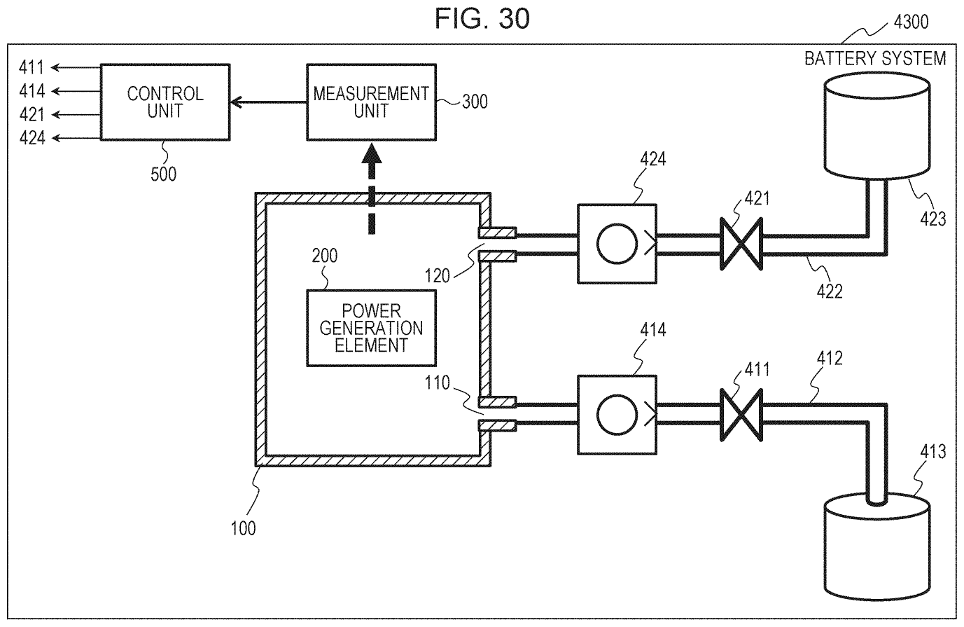

FIG. 29 is a flowchart illustrating an exemplary control method according to the fourth embodiment.

The control method illustrated in FIG. 29 further includes a discharge step S4004 in addition to the above-described control method illustrated in FIG. 24.

The discharge step S4004 is performed after the opening step S4002. In the discharge step S4004, the gas inside the container 100 is discharged by the second gas discharge unit 424 to the second gas storage unit 423 through the second outlet 120.

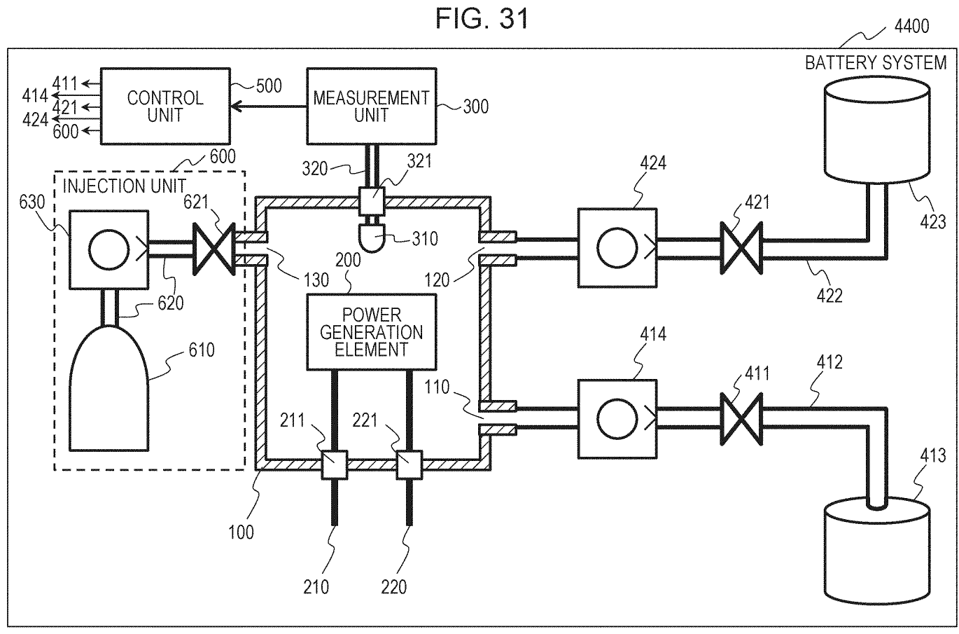

FIG. 30 illustrates a general configuration of a battery system 4300 according to the fourth embodiment.

According to the fourth embodiment, the second outlet 120 may be an opening provided on a side surface of the container 100 as illustrated in FIG. 30. Alternatively, the second outlet 120 may be provided at a portion (e.g., corner) other than the side surface of the container 100. The shape of the second outlet 120 may be circular, elliptic, rectangular, linear, or the like.

In addition, as the second opening and closing unit 421 according to the fourth embodiment, the configuration described as the first opening and closing unit 411 in the first embodiment or the like may be used as appropriate. For example, as illustrated in FIG. 30, the second opening and closing unit 421 may be a valve (e.g., control valve).

In addition, as the second discharge path 422 according to the fourth embodiment, the configuration described as the first discharge path 412 in the third embodiment or the like may be used as appropriate. For example, the second discharge path 422 may be a pipe. Note that the second gas discharge unit 424 may be provided with the apparatuses described as the discharge assistance unit 415 and the opening and closing unit 416 in the third embodiment or the like as appropriate.

In addition, as the second gas storage unit 423 according to the fourth embodiment, the configuration described as the first gas storage unit 413 in the third embodiment or the like may be used as appropriate. For example, as illustrated in FIG. 30, the second gas storage unit 423 may be a tank.

In addition, as the second gas discharge unit 424 according to the fourth embodiment, the configuration described as the second gas discharge unit 424 in the third embodiment or the like may be used as appropriate. For example, as illustrated in FIG. 30, the second gas discharge unit 424 may be a pump.

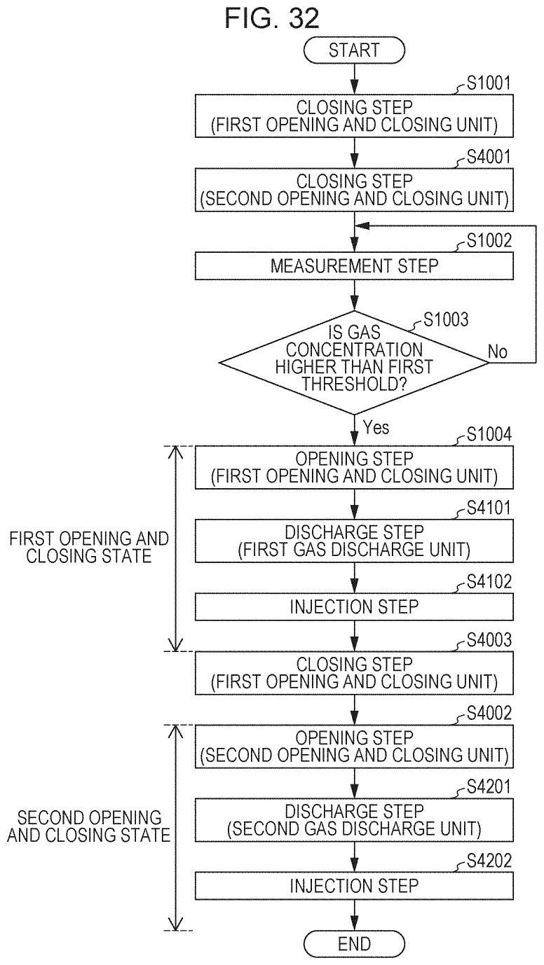

FIG. 31 illustrates a general configuration of a battery system 4400 according to the fourth embodiment.

The battery system 4400 according to the fourth embodiment further includes the configuration of the battery system 2100 according to the second embodiment, in addition to the above-described configuration of the battery system 4300 according to the fourth embodiment.

That is, the battery system 4400 according to the fourth embodiment includes the injection unit 600.

Note that the control unit 500 in the battery system 4400 according to the fourth embodiment controls the first opening and closing unit 411, the first gas discharge unit 414, the second opening and closing unit 421, the second gas discharge unit 424, and the injection unit 600 (e.g., the inlet opening and closing unit 621 and the injection assistance unit 630).

Note that in the fourth embodiment, the first outlet 110, the second outlet 120, the inlet 130, the sensor element 310, and electrode terminals (the first electrode terminal 210 and the second electrode terminal 220) may be provided on different faces of the container 100 as illustrated in FIG. 31, or may be provided on the same face.

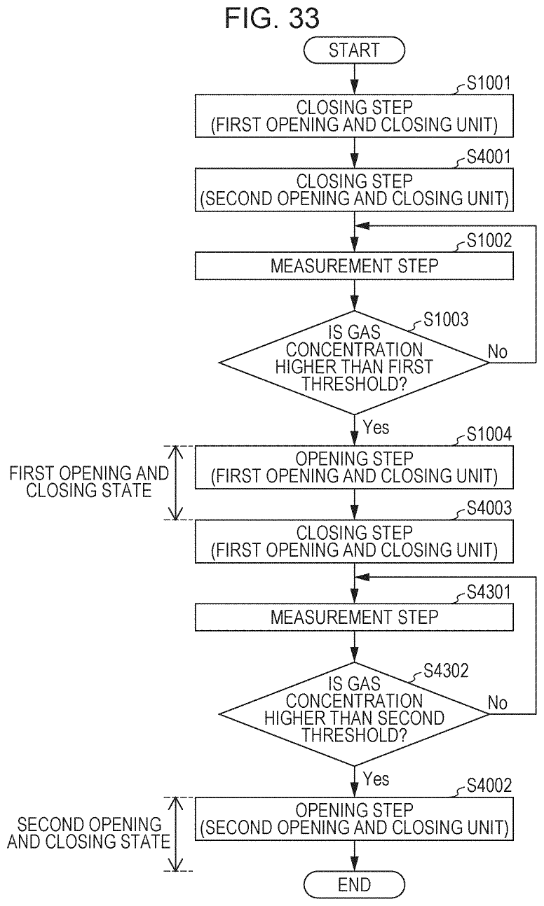

FIG. 32 is a flowchart illustrating an exemplary control method according to the fourth embodiment.

The control method illustrated in FIG. 32 further includes the following steps in addition to the above-described control method illustrated in FIG. 26.

That is, the control method illustrated in FIG. 32 includes a discharge step S4101 and an injection step S4102 performed between the opening step S1004 and the closing step S4003.

In addition, the control method illustrated in FIG. 32 further includes a discharge step S4201 and an injection step S4202 performed after the opening step S4002.

In the discharge step S4101, the gas inside the container 100 is discharged by the first gas discharge unit 414 to the first gas storage unit 413 through the first outlet 110.

In the discharge step S4201, the gas inside the container 100 is discharged by the second gas discharge unit 424 to the second gas storage unit 423 through the second outlet 120.

In the injection step S4102 and the injection step S4202, the injection unit 600 injects the reference gas into the inside of the container 100 through the inlet 130.

With the above control method, in both the first opening-and-closing-state and the second opening-and-closing-state, the reference gas can be injected into the inside of the container 100. Thus, in both the first opening-and-closing-state and the second opening-and-closing-state, the gas inside the container 100 can be replaced with the reference gas. Accordingly, the gas can be discharged from the inside of the container 100 to the first gas storage unit 413 and the second gas storage unit 423 more reliably.

Note that after the gas concentration (i.e., the gas concentration inside the container 100 measured by the measurement unit 300 while the first opening and closing unit 411 and the second opening and closing unit 421 are in a closed state) has exceeded the second threshold (predetermined threshold), the control unit 500 according to the fourth embodiment may generate the second opening-and-closing-state.

With the above configuration, the path for discharging the gas can be switched in accordance with the measured gas concentration. That is, after the gas has been discharged from a path through the first outlet 110 in the first opening-and-closing-state, if the gas concentration increases again to exceed the second threshold, the state may be switched to the second opening-and-closing-state (i.e., the gas can be discharged from a path through the second outlet 120). Thus, the amount of gas discharged through the first outlet 110 (e.g., discharged to the first gas storage unit 413) and the amount of gas discharged through the second outlet 120 (e.g., discharged to the second gas storage unit 423) can be adjusted by changing the setting of the first threshold and the second threshold.

Note that the second threshold may be equal to the first threshold. In this case, the amount of gas discharged through the first outlet 110 can be equal to the amount of gas discharged through the second outlet 120.

Alternatively, the second threshold may be higher than the first threshold. In this case, the amount of gas discharged through the first outlet 110 can be larger than the amount of gas discharged through the second outlet 120.

Alternatively, the second threshold may be lower than the first threshold. In this case, the amount of gas discharged through the first outlet 110 can be smaller than the amount of gas discharged through the second outlet 120.

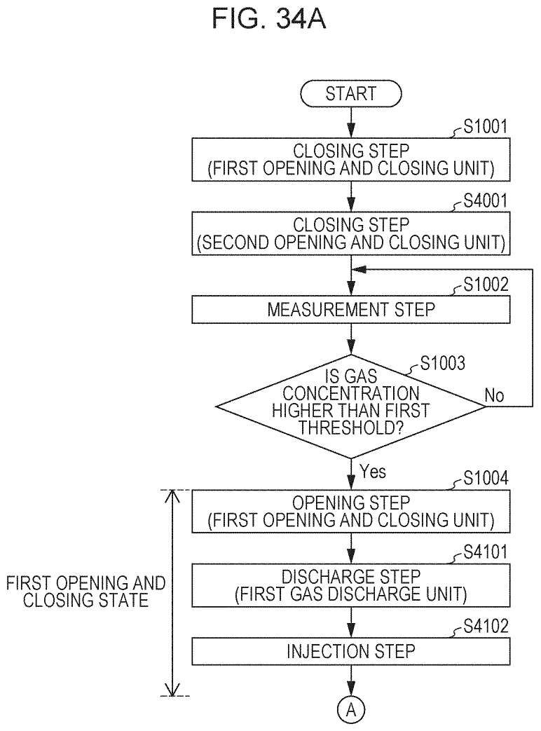

FIG. 33 is a flowchart illustrating an exemplary control method according to the fourth embodiment.

The control method illustrated in FIG. 33 further includes the following steps in addition to the above-described control method illustrated in FIG. 26.

That is, the control method illustrated in FIG. 33 includes a measurement step S4301 and a determination step S4302 performed between the closing step S4003 and the opening step S4002.

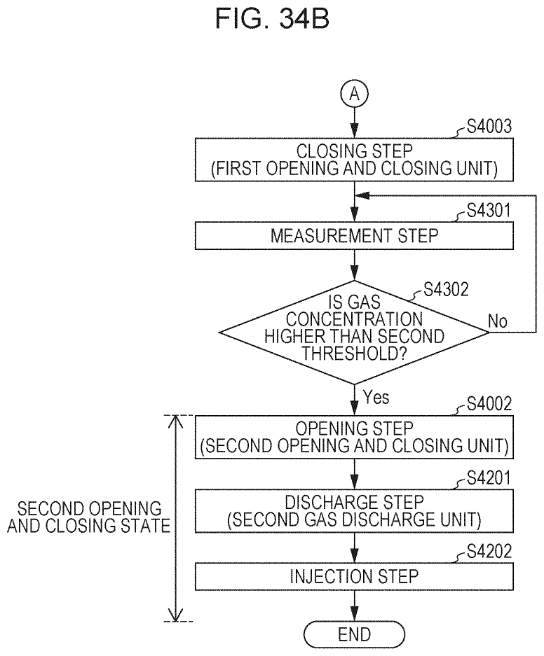

FIGS. 34A and 34B are a flowchart illustrating an exemplary control method according to the fourth embodiment.

The control method illustrated in FIGS. 34A and 34B further includes the following steps in addition to the above-described control method illustrated in FIG. 32.

That is, the control method illustrated in FIGS. 34A and 34B includes the measurement step S4301 and the determination step S4302 performed between the closing step S4003 and the opening step S4002.

In the measurement step S4301, the measurement unit 300 measures the gas concentration while the first opening and closing unit 411 and the second opening and closing unit 421 are in a closed state.

The determination step S4302 is performed after the measurement step S4301. In the determination step S4302, the control unit 500 determines whether the gas concentration is higher than the second threshold. If it is determined that the gas concentration is not higher than the second threshold, the measurement step S4301 is performed again. If it is determined that the gas concentration is higher than the second threshold, the opening step S4002 is performed.

Note that the configurations described in the first to fourth embodiments may be combined as appropriate.

The battery system according to an embodiment of the present disclosure is applicable to an in-vehicle battery system (e.g., battery system for vehicles), a battery system for a charging station (e.g., stationary battery system), and the like.

### Fifth Embodiment

Now, a fifth embodiment will be described below. A repeated description of any of the above-described first to fourth embodiments will be omitted as appropriate.

Like the fourth embodiment shown in the FIGS. 23, 27, 28, 30 and 31, the battery system according to the fifth embodiment includes: a container 100 including a first outlet 110 and a second outlet 120, a power generation element 200 contained in the container 100 and disposed inside the container 100, a measurement unit 300 that measures a gas concentration inside the container 100, a first opening and closing unit 411 connected to the first outlet 110, a second opening and closing unit 421 connected to the second outlet 120, and a control unit 500 that controls the first opening and closing unit 411 and the second opening and closing unit 421.

Mainly, the differences between the fifth embodiment and the fourth embodiment are described below.

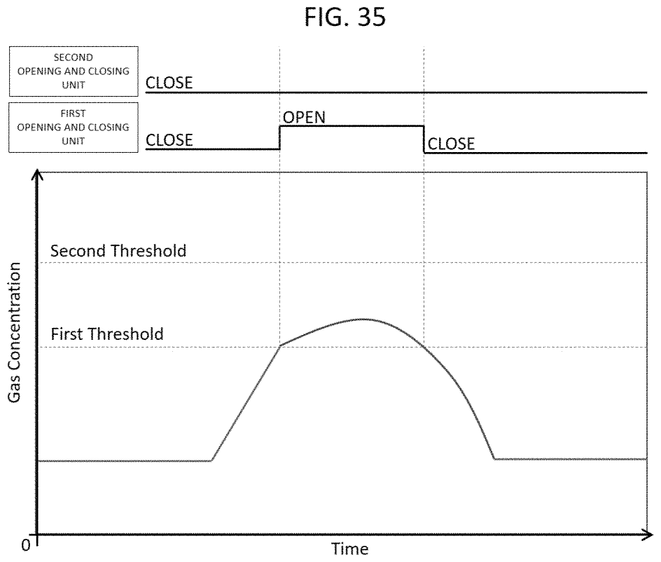

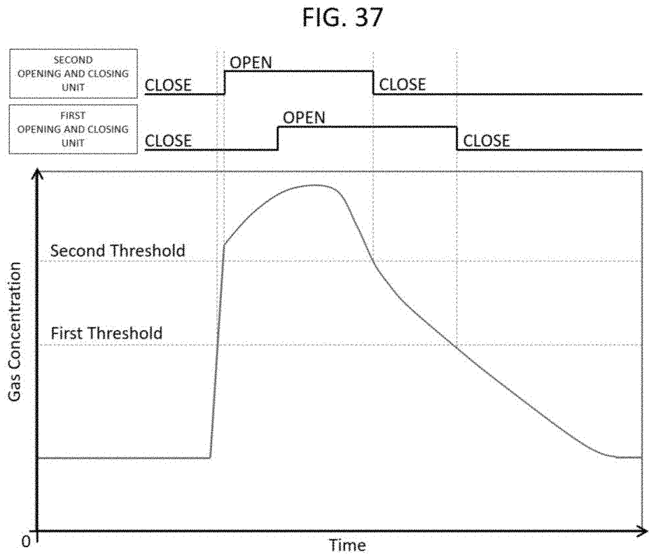

FIGS. 35 to 37 illustrate respectively an operation example of a battery system according to the fifth embodiment.

the measurement unit 300 measures a first gas concentration. The first gas concentration is the gas concentration while the first opening and closing unit 411 is in a closed state.

The control unit 500 sets the first opening and closing unit 411 to an open state after the first gas concentration has exceeded a first threshold, as shown in the FIGS. 35 to 37.

The measurement unit 300 measures a second gas concentration. The second gas concentration is the gas concentration while the second opening and closing unit 421 is in a closed state.

The control unit 500 sets the second opening and closing unit 421 to an open state after the second gas concentration has exceeded a second threshold, as shown in the FIGS. 35 to 37.

With the above configuration, the path for discharging the gas can be adjusted in accordance with the measured gas concentration (i.e., the first and second gas concentration). That is, the amount of gas discharged through the first outlet 110 (e.g., discharged to the first gas storage unit 413) and the amount of gas discharged through the second outlet 120 (e.g., discharged to the second gas storage unit 423) can be adjusted by changing the setting of the first threshold and the second threshold.

The second gas concentration may be the gas concentration while the second opening and closing unit 421 is in the closed state and the first opening and closing unit 411 is in the open state.

With the above configuration, with the measurement result of the measurement unit 300, it can be detected whether the amount of the generating gas is higher than the amount of gas discharged through the first outlet 110 or not.

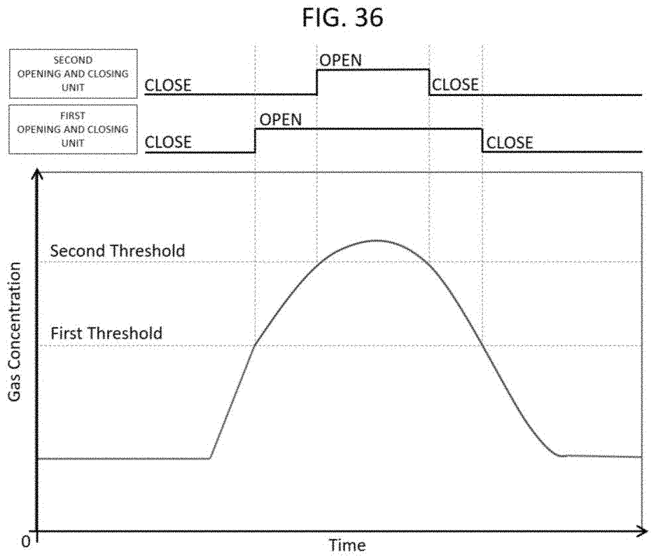

The second threshold may be higher than the first threshold. In this case, as shown in the FIG. 36, even if the amount of the generating gas is higher than the amount of gas discharged through the first outlet 110, a gas discharge through the second outlet 120 can additionally be performed.

Note that the second threshold may be lower than the first threshold. The second threshold may be different from the first threshold. Alternatively, the second threshold may be equal to the first threshold.

The control unit 500 may set the second opening and closing unit 421 to the closed state after the second gas concentration has be not greater than the second threshold.

With the above configuration, the amount of gas discharged through the second outlet 120 can be reduced.

The control unit 500 may set the first opening and closing unit 411 to the closed state after the first gas concentration has be not greater than the first threshold.

With the above configuration, the amount of gas discharged through the first outlet 110 can be reduced.

Note that the configurations described in the first to fifth embodiments may be combined as appropriate.

What is claimed is:

1. A battery system comprising:
a container including a first outlet and a second outlet;
a power generation element contained in the container and disposed inside the container;
a measurement unit that measures a gas concentration inside the container;
a first opening and closing unit connected to the first outlet;
a second opening and closing unit connected to the second outlet; and
a control unit that controls the first opening and closing unit and the second opening and closing unit,
wherein the measurement unit measures a first gas concentration which is the gas concentration while the first opening and closing unit is in a closed state,
wherein the control unit sets the first opening and closing unit to an open state after the first gas concentration has exceeded a first threshold,
wherein the measurement unit measures a second gas concentration which is the gas concentration while the second opening and closing unit is in a closed state, and
wherein the control unit sets the second opening and closing unit to an open state after the second gas concentration has exceeded a second threshold.

2. The battery system according to claim 1,
wherein the second gas concentration is the gas concentration while the second opening and closing unit is in the closed state and the first opening and closing unit is in the open state.

3. The battery system according to claim 2,
wherein the control unit sets the second opening and closing unit to the closed state after the second gas concentration has be not greater than the second threshold.

4. The battery system according to claim 1,
wherein the control unit sets the first opening and closing unit to the closed state after the first gas concentration has be not greater than the first threshold.

5. The battery system according to claim 1,
wherein the second gas concentration is the gas concentration while the second opening and closing unit and the first opening and closing unit are in the closed state, and
wherein the control unit sets the second opening and closing unit to an open state and sets the first opening and closing unit to the closed state after the second gas concentration has exceeded the second threshold.

6. The battery system according to claim 1, further comprising:
an injection unit,
wherein the container includes an inlet,
wherein the injection unit injects a reference gas into an inside of the container through the inlet,
wherein the control unit controls the injection unit, and
wherein the control unit causes the injection unit to inject the reference gas into the inside of the container through the inlet after the first opening and closing unit has been set to the open state.

7. The battery system according to claim 6,
wherein the control unit opens and closes the first opening and closing unit a plurality of times while the injection unit injects the reference gas into the inside of the container through the inlet.

8. The battery system according to claim 6,
wherein the injection unit includes a reference gas source, an injection path, and an injection assistance unit,
wherein the reference gas is supplied from the reference gas source,
wherein a first end of the injection path is connected to the reference gas source,
wherein a second end of the injection path is connected to the inlet, and
wherein the control unit makes a pressure of the injection path a positive pressure with respect to a pressure inside the container by using the injection assistance unit.

9. The battery system according to claim 6,
wherein the reference gas is a dehumidified gas or an inert gas.

10. The battery system according to claim 1, further comprising:
a first discharge path; and
a first gas storage unit,
wherein a first end of the first discharge path is connected to the first opening and closing unit, and
wherein a second end of the first discharge path is connected to the first gas storage unit.

11. The battery system according to claim 10, further comprising:
a first gas discharge unit,
wherein the first gas discharge unit discharges the gas inside the container to the first gas storage unit through the first outlet,
wherein the control unit controls the first gas discharge unit, and
wherein the control unit causes the first gas discharge unit to discharge the gas to the first gas storage unit through the first outlet after the first opening and closing unit has been set to the open state.

12. The battery system according to claim 10, further comprising:
a discharge assistance unit,
wherein the first gas storage unit is a first gas storage tank,
wherein the control unit controls the discharge assistance unit, and
wherein the control unit makes a pressure inside the first gas storage tank a negative pressure with respect to a pressure inside the container by using the discharge assistance unit.

13. The battery system according to claim 10, further comprising:
a discharge assistance unit,
wherein the control unit controls the discharge assistance unit, and
wherein the control unit makes a pressure inside the container a negative pressure with respect to a pressure outside the container by using the discharge assistance unit.

14. The battery system according to claim 11, further comprising:
a reactant introducing unit,
wherein the reactant introducing unit introduces a reactant that reacts with the gas into the first gas storage unit,
wherein the control unit controls the reactant introducing unit, and
wherein the control unit causes the reactant introducing unit to introduce the reactant into the first gas storage unit after the first gas discharge unit has discharged the gas to the first gas storage unit through the first outlet.

15. The battery system according to claim 10,
wherein the first gas storage unit includes the reactant that reacts with the gas.

16. The battery system according to claim 14,
wherein the power generation element includes a sulfide-based material,
wherein the gas is hydrogen sulfide generated from the sulfide-based material, and
wherein the reactant is at least one selected from the group consisting of sodium hydroxide, sodium carbonate, a copper(II) sulfate aqueous solution, and hydrogen peroxide.

17. The battery system according to claim 1, further comprising:
a second discharge path; and
a second gas storage unit,
wherein a first end of the second discharge path is connected to the second opening and closing unit, and
wherein a second end of the second discharge path is connected to the second gas storage unit.

18. The battery system according to claim 17, further comprising:
a second gas discharge unit,
wherein the second gas discharge unit discharges the gas inside the container to the second gas storage unit through the second outlet,
wherein the control unit controls the second gas discharge unit, and
wherein the control unit causes the second gas discharge unit to discharge the gas to the second gas storage unit through the second outlet after the second opening and closing unit has been set to the open state.
